(19) United States
(12) Patent Application Publication
(10) Pub. No.: US 2010/0143589 A1
(43) Pub. Date: Jun. 10, 2010

(54) AQUEOUS INKJET INKS WITH IONICALLY STABILIZED DISPERSIONS AND POLYURETHANE INK ADDITIVES

(76) Inventors: HARRY JOSEPH SPINELLI, Wilmington, DE (US); C. Chad Roberts, Wilmington, DE (US); Nathaniel Reed Schwartz, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/328,110

(22) Filed: Dec. 4, 2008

(51) Int. Cl. B05D 5/06; C08L 75/04

(52) U.S. Cl. 427/256; 524/589; 524/590

(57) ABSTRACT

Inks that contain ionically stabilized dispersions and selected polyurethane ink additives are described. These ionically stabilized dispersions are obtained from polymeric dispersants where the hydrophilic components are minimized. These stabilized dispersions can be utilized to prepare ink jet inks which when printed result in improved optical density, chroma, gloss and especially distinctness of image. The stability of the ionically stabilized dispersions are sufficient for ink jet inks. The polyurethane ink additives are chosen from polyurethanes which are urea terminated or crosslinked.

### CROSS-REFERENCE TO RELATED APPLICATION

This application claims priority under 35 U.S.C. §119 from U.S. Provisional Application Ser. No. 60/007,021 (filed Dec. 10, 2007), the disclosure of which is incorporated by reference herein for all purposes as if fully set forth.

### BACKGROUND OF THE INVENTION

This invention relates to novel aqueous inkjet inks with pigments dispersed using ionically stabilized polymeric dispersants and selected polyurethanes ink additives that are combined to produce the inks and the use thereof in ink jet inks.

Aqueous dispersions of pigments are known in the art and have been used in various applications such as, for example, inks for printing (particularly ink jet printing); waterborne paints and other coating formulations for vehicles, buildings, road markings and the like; cosmetics; pharmaceutical preparations; etc. Because pigments are typically not soluble in an aqueous vehicle, it is often required to use dispersing agents, such as polymeric dispersants or surfactants, to produce a stable dispersion of the pigment in the vehicle.

An application of the present invention relates to an ink (printing liquid) useful for writing utensils such as aqueous ball point pens, fountain pens and felt-tip pens; continuous and on-demand type inkjet printers of a thermal jet type, a piezo type and the like; and an inkjet printing method employing the ink.

Aqueous pigment dispersions generally are stabilized by either a non-ionic or ionic technique. When the non-ionic technique is used, a polymer having a non-ionic hydrophilic section that extends into the water medium is typically employed. The hydrophilic section provides entropic or steric stabilization that stabilizes the pigment particles in the aqueous vehicle. Polyvinyl alcohol, cellulosics, ethylene oxide modified phenols and ethylene oxide/propylene oxide polymers may be used for this purpose.

While the non-ionic technique is not sensitive to pH changes or ionic contamination, it has a major disadvantage in that the printed image is water sensitive.

In the ionic technique, the pigment particles are stabilized using the polymer of an ion containing monomer, such as neutralized acrylic, maleic or vinyl sulfonic acid. The polymer provides stabilization through a charged double layer mechanism whereby ionic repulsion hinders the particles from flocculation. Since the neutralizing component tends to evaporate after printing, the polymer then has reduced water solubility and the printed image is less water sensitive than the nonionic stabilized pigments.

There continues to be a need for higher-quality and different property inks for inkjet ink applications. For instance, photographic and other highly colored printing requires improved inkjet inks. Although improvements in ink additives and polymeric dispersants have significantly contributed to improved inkjet inks, the current dispersants still do not provide inks with requisite optical density and chroma needed for emerging ink jet applications.

A new class of dispersants was described in US2005/0090599. These ionically stabilized dispersions are described that are substantially free of steric stabilization of the pigment. These ionically stabilized dispersions are obtained from polymeric dispersants where the hydrophilic components are minimized. While these dispersants resulted in inks with superior properties, there is still a need to find additives that optimize the properties of these ionically stabilized dispersions for use in inkjet inks. These additives must improve properties without sacrificing other ink attributes, for instance improving image color properties such as chroma without sacrificing optical density.

Polyurethanes have been used as additives to ink jet inks with varying degrees of success. For instance, U.S. Pat. No. 7,176,248 describes the use of polyurethane additives to self dispersed pigments in inkjet inks, especially inks for piezo inks.

U.S. Pat. No. 6,908,185 discusses the combination of self-dispersed pigments, polyurethanes with a molecular weight of 3000 to 10000 and a fixer.

US 2005/0176848 A1 claims and discusses the combination of a water soluble PUD, a pigment, and a 1,2-alkyldiol. While a litany of potential dispersant types are given the only examples are based on self dispersed pigments.

US 2004/0229976 A1 and EP1454968 A1 describes and claims a combination of pigment dispersion and PUD where the PUD is dispersible and has a urea content of less than 2.0%. The pigment dispersion may be a self dispersed pigment or a “conventionally” dispersed pigment.

While inks based on aqueous dispersions with polyurethane additives have provided improved ink jet inks for many aspects of ink jet printing, still there are opportunities to improve the inks. One particularly important opportunity is obtaining improved optical density; chroma and especially gloss and distinctness of image (DOI). These must be achieved while maintaining other aspects of the ink especially the pigmented dispersions, such as dispersion stability, long nozzle life and the like.

All of the above-identified publications are incorporated by reference herein for all purposes as if fully set forth.

### SUMMARY OF THE INVENTION

The use of polymeric conventional dispersants with known ink additives is well established as a means to make inks especially ink jet inks. In general, these conventional dispersants have, at least, modest water solubility and this water solubility is used as a guide to predicting dispersion stability. During diligent searching for new, improved polymeric dispersants, a new class of dispersants has been found that has little water solubility or miscibility, and very limited hydrophilic content, and can be used to produce stable aqueous dispersions with new and improved properties. The new class of dispersants was described in US2005/0090599, which disclosure is incorporated by reference herein for all purposes as if fully set forth. It was further surprisingly discovered herein that when these new dispersions are utilized in inks with at least one specific type of polyurethane ink additive enhanced optical properties of the printed materials derived from these inks can be achieved.

Previously, it has been found that the new class of dispersants described in US2005/0090599 produce stable aqueous dispersions via ionic stabilization with substantially no steric stabilization. When these dispersions are utilized for ink jet inks, images printed with the ink display both improved optical density, chroma, and distinctness of image. In accordance with the invention, when these new class of dispersants are combined with at least one polyurethane ink additive as described herein, the presence of the selected polyurethane unexpectedly improves chroma and distinctness of image while not reducing optical density.

Dispersions containing this new class of dispersants are referred to herein as ionically stabilized dispersions (ISD's). The dispersants themselves are referred to as ISD polymer dispersants.

Accordingly, there are provided inks which have dispersants that lead to stable aqueous dispersions of pigments using the ISD polymer dispersants and polyurethane ink additive; inks sets comprising at least one ink based on an ISD and a polyurethane ink additive, and methods of ink jet printing that use the inks and ink sets based on ISD's and the polyurethane ink additive.

In accordance with one aspect of the present invention, there is provided an aqueous ink with a polyurethane ink additive and a pigment dispersion comprising a pigment and a polymeric, ionic dispersant in an aqueous vehicle, wherein:

(a) the ionic dispersant is physically adsorbed to the pigment,

(b) the polymeric ionic dispersant stably disperses the pigment in the aqueous vehicle,

(c) the average particle size of the dispersion is less than about 300 nm, and

(d) when three drops of the ink is added to about 1.5 g of an aqueous salt solution of about 0.20 molar salt, the pigment precipitates out of the aqueous salt solution when observed 24 hours after the addition; and

wherein the polyurethane ink additive is selected from the group consisting essentially of

a.) a urea terminated polyurethane where the weight fraction of the urea-terminated polyurethane part of the polyurethane is at least 2 wt % to the urethane resin;

b.) a crosslinked polyurethane in the amount in the ink of more than about 0.5% to about 30% by weight based on the total weight of the aqueous ink, and wherein the amount of crosslinking in the crosslinked polyurethane is greater than about 1% and less than about 50% as determined by the THF insolubles test.

In accordance with another aspect of the present invention, there is provided an aqueous ink with a polyurethane ink additive and a pigment dispersion comprising a pigment and a polymeric, ionic dispersant in an aqueous vehicle, wherein:

(a) the ionic dispersant is physically adsorbed to the pigment,

(b) the polymeric ionic dispersant stably disperses the pigment in the aqueous vehicle via ionic stabilization with substantially no steric stabilization, and

(c) the average particle size of the dispersion is less than about 300 nm.

In accordance with another aspect of the present invention, there is provided an aqueous pigmented ink jet ink comprising an aqueous pigment dispersion with a polyurethane ink additive as described above, having from about 0.05 to about 10 wt % polyurethane ink additive based on the total weight of the ink, having from about 0.1 to about 10 wt % pigment based on the total weight of the ink, a weight ratio of pigment to dispersant of from about 0.5 to about 6, a surface tension in the range of about 20 dyne/cm to about 70 dyne/cm at 25° C., and a viscosity of lower than about 30 cP at 25° C.

In still another aspect of the present invention, there is provided an ink set comprising at least one cyan ink, at least one magenta ink, at least one yellow ink and optionally at least one black ink, wherein at least one of the inks is an aqueous pigmented ink jet ink with an ionically stabilized pigment dispersion and at least one selected polyurethane ink additive as set forth above and described in further detail below.

In yet another aspect of the present invention, there is provided a method for ink jet printing onto a substrate, comprising the steps of:

(a) providing an ink jet printer that is responsive to digital data signals;

(b) loading the printer with a substrate to be printed;

(c) loading the printer with an ink as set forth above and described in further detail below, or an ink jet ink set as set forth above and described in further detail below; and

(d) printing onto the substrate using the ink or inkjet ink set in response to the digital data signals.

The combination of ISD dispersed pigments and the selected polyurethane Ink additives lead to inks that when images are printed the images have optical densities that rival those achieved with self dispersed pigments, but have significantly improved gloss and distinctness of image. The images are also more smear resistant and more durable.

### DETAILED DESCRIPTION OF THE PREFERRED EMBODIMENTS

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting. Although methods and materials similar or equivalent to those described herein can be used in the practice or testing of the present invention, suitable methods and materials are described herein.

Accordingly, there are provided inks which have dispersants that lead to stable aqueous dispersions of pigments using the Ionically Stabilized Dispersants (ISD) polymer dispersants and selected polyurethane ink additive; inks sets comprising at least one ink based on an ISD and the selected polyurethane ink additive, and methods of ink jet printing that use the inks and ink sets based on ISD's and the selected polyurethane ink additive; where the selected polyurethanes are selected from the group consisting essentially of

a.) a urea terminated polyurethane where the weight fraction of the urea-terminated polyurethane part of the polyurethane is at least 2 wt % to the urethane resin;

b.) a crosslinked polyurethane in the amount in the ink of more than about 0.5% to about 30% by weight based on the total weight of the aqueous ink, and wherein the amount of crosslinking in the crosslinked polyurethane is greater than about 1% and less than about 50% as determined by the THF insolubles test.

The aqueous pigmented ink jet ink comprises a polyurethane, an aqueous pigment dispersion in an aqueous vehicle, wherein: the aqueous pigment dispersion comprises an ionic dispersant and pigment where

(a) the ionic dispersant is physically adsorbed to the pigment,

(b) the polymeric ionic dispersant stably disperses the pigment in the aqueous vehicle,

(c) the average particle size of the dispersion is less than about 300 nm, and

(d) when three drops of the ink is added to about 1.5 g of an aqueous salt solution of about 0.20 molar salt, the pigment precipitates out of the aqueous salt solution when observed 24 hours after the addition; and

and wherein the polyurethane ink additive is selected from the group consisting essentially of, and preferably consisting only of,

a.) a urea terminated polyurethane where the weight fraction of the urea-terminated polyurethane part of the polyurethane is at least 2 wt % to the urethane resin;

b.) a crosslinked polyurethane in the amount in the ink of more than about 0.5% to about 30% by weight based on the total weight of the aqueous ink, and wherein the amount of crosslinking in the crosslinked polyurethane is greater than about 1% and less than about 50% as determined by the THF insolubles test.

The inks of the present invention have ionically stabilized pigment dispersions and the polyurethane ink additive. The pigment dispersion is made in a dispersion process by dispersing the pigment with the ionically stabilized dispersant. In turn, the ink is preferably prepared by adding in any order the polyurethane ink additive along with the vehicle and other ink components to the ionically stabilized dispersion.

These polyurethane ink additives are preferable dispersions in the aqueous inks. In other words, the polyurethane ink additives are added at the ink formulation stage as a dispersed polymer additive. The chemical features of the urea terminated polyurethane and crosslinked polyurethane are chosen such that they will be stable dispersions in a typical aqueous ink formulation.

The combination of ISD dispersed pigments and the selected polyurethane Ink additives leads to inks that when images are printed the images have optical densities that rival those achieved with self dispersed pigments, but have significantly improved gloss and distinctness of image. The images are also more smear resistant and more durable. When this combination is compared to the polyurethane additive addition to inks with conventional polymeric dispersed pigments, the optical density goes down and the DOI also is reduced. Likewise adding the polyurethane additive to inks with self dispersed pigments result in comparable optical densities, improved gloss and DOI, but the combination does not produce optical properties as good as the ISD/polyurethane ink additive combination described herein.

This surprising result may be due to interactions of the polyurethane and the ISD when the ink first encounters the print substrate. Without being bound by theory, although the polyurethane is hydrophobic it may have sufficient hydrophilic properties especially through the hydrogen bonding sites of the polyurethane to produce the enhance effects that results in unreduced optical density while significantly improving gloss and distinctness of image. These improvements are believed to enable the success of ink jet inks in making high color images, especially for photo printing.

### Ionically Stabilized Dispersions

The science and art of producing stable dispersions utilizing organic polymeric dispersants has been studied and extensively developed. In this literature the types of dispersants are characterized based on the perceived mechanism(s) of stabilization. Thus, polymeric dispersions can stabilize dispersions by steric and electrostatic stabilization. In order to provide effective steric or electrosteric stabilization, the dispersant must adhere to the particle surface and have an interaction with the dispersion medium. Both requirements can be satisfied, by a polymeric dispersant with a dual functionality, featuring one or more functional groups or segments that attach or interact with the particle surfaces, and segments or tails that extend into the dispersion medium and provide the barrier needed for stabilization. In fact, the optimization of the dual functionality has lead to many improved pigment dispersions. This dual functionality is achieved by utilizing polymers with hydrophilic and hydrophobic segments.

Alternatively the polymeric dispersant can stabilize the pigment by an ionic mechanism. That is, the described polymeric dispersant systems suggest that the stabilization mechanism comes from the polymer providing stabilization through a charged double layer mechanism whereby ionic repulsion hinders the particles from flocculating (see U.S. Pat. No. 5,085,698).

Although polymeric dispersants are most often described as leading to stabilization via steric, or ionic mechanisms, in fact it appears that most if not all current polymeric dispersant systems stabilize by combinations of both mechanisms. Those stabilizations that are described solely in the context of a single mechanism are now believed to be combinations of steric and ionic mechanisms.

In the context of the present invention, it has now been recognized that polymeric dispersants that function with substantially no steric stabilization can still successfully stabilize a dispersion.

Thus, polymers were sought that had a new balance of properties. The hydrophobic nature of the polymers is important in that it can attach to the pigment surface, most likely by van der Waals and similar non-bonding forces (physical adsorption to the pigment). The major difference between the instant invention and the previously described systems is that, in accordance with the present invention, the hydrophilic portion of the polymer is significantly reduced. Furthermore, the hydrophobic/hydrophilic segments of the polymers are distributed in the polymer to minimize large molecular regions of hydrophilic components. These high densities of hydrophilic groups can lead to undesirable steric stabilization.

This new balance in properties results in aqueous pigment dispersions where the polymeric stabilization is almost solely due to ionic stabilization, with little or no steric stabilization. While there are spectroscopic means to determine the presence of steric stabilization as described in “Powders, Handling, Dispersion of Powders in Liquids”, Kirk-Othmer Encyclopedia of Chemical Technology, John Wiley and Sons (2003), a more routine method has been developed to characterize the aqueous pigment ISD's in accordance with the present invention that utilize the ISD polymeric dispersants. This method is called the salt stability test.

### Salt Stability Test

A series of different concentration aqueous salt solutions (typically NaCl) are prepared. For each salt solution, approximately 1.5 ml (about 1.5 g) is added to a small glass vial.

For a pigment dispersion “concentrate”, one drop is added to the salt solution and gently mixed. For a pigment dispersion concentrate of about 15 wt % total solids (typical), one drop would typically be about 0.04 g total. The test for inks (which can be considered diluted forms of the concentrates) is very similar for the salt stability test for pigment dispersion concentrates, except that the solids content of inks is lower than that of a pigment dispersion concentrate, so the volume of ink added to the salt solution needs to be increased to maintain the same approximate amount of solids. Based on a typical ink of about 5 wt % total solids, about three times the weight of ink (as compared to concentrate) is needed.

Taking the case of the pigment dispersion concentrate mentioned above, the weight of solids from the concentrate would be about 0.006 g in about 1.5 g of the aqueous salt test solution, or about 0.4% by weight based on the weight of the aqueous salt test solution.

It should be noted that the 0.4% by weight number derived above is not critical for the application of the salt stability test, but can be used as a standard point if so desired. Because the results of the salt stability test are more related to the concentration of salt as compared to solids, and because it may be somewhat difficult to precisely determine the solids content of a pigment dispersion, for a standard of measurement the following convention will be adopted:

for pigment dispersions considered to be concentrates (about 10 wt % or more solids), one drop of dispersion should be used for 1.5 ml salt solution;

for pigment dispersions of an intermediate solids content (inks and/or concentrates of about 5-10 wt % solids), two drops of dispersion should be used for 1.5 ml salt solution, and

for more dilute pigment dispersions (such as inks having about 5 wt % solids or less), three drops of dispersion should be used for 1.5 ml salt solution.

For the inks of the present invention three drops are used to do this salt stability test, although one or two drops may be used if the pigment dispersion has higher concentrations.

Based on the above, the appropriate amount of the pigment dispersion is added to the salt solution and gently mixed. After sitting undisturbed for 24 hours at room temperature, sample stability is rated as follows:
Rating of 3: complete settling of pigment; transparent, uncolored liquid at top.
Rating of 2: no transparent uncolored liquid layer; definite settling onto bottom of vial observed when vial is tilted.
Rating of 1: no transparent uncolored liquid layer; very slight settling (small isolated spots) as observed during tilting of vial.
Rating of 0: no evidence of any settling.

The salt concentration where settling is definitely observed (a rating of 2 or 3) is taken as the critical flocculation concentration for the pigment dispersion. It can be inferred from this test that, with increasing critical flocculation concentration, the role of polymeric (steric) stabilization becomes more dominant and electrostatic stabilization becomes a less important stabilization mechanism.

The ISD polymer dispersants which satisfy the requirements for the invention are those that give pigment dispersions that are rated at 2 or 3 at a concentration of salt of 0.2 molar. That is, ISD polymer dispersants of this invention, when associated with a pigment in an ISD, and when tested by the salt stability test, will be observed to precipitate from the test solution at 0.2 molar salt concentration. Rating criteria 2 and 3 will each meet the criteria of precipitation. More preferred are pigment dispersions that are rated at 2 or 3 at a concentration of salt of about 0.18 molar or lower. Even more preferred are pigment dispersions that are rated at 2 or 3 at a concentration of salt of about 0.16 or lower.

The preferred salts for the aqueous salt solution are lithium, sodium or potassium salts.

As indicated above, and for further clarification, the salt stability test is applicable to a wide variety of pigment dispersion solids contents. While the one, two or three drop definition for the test does not specifically define an amount of solids added, the test is quite flexible and it has been found that these generalities are sufficient to effectively rate samples in a consistent manner. In other words, the test as defined above provides consistent and meaningful results despite variations in the solids contents of the dispersions tested, and has been thus adopted as a definition in the context of the present invention. Further details and actual application of the salt stability test (which particularly demonstrate this consistency of results) are provided in the Examples section below.

The ionically stabilized dispersions of the current invention are stabilized by a minimal amount of ionic content in the dispersant and limited, or negligible steric stabilization content in the dispersant. It is surprising that the resulting pigment dispersions are as stable as they are with so little ionic components. The salt stability test is a means to distinguish this low ionic character of the dispersion in that the dispersion will be negatively impacted by the addition of salts. This impact is observed in the pigment precipitates that are described in the salt stability test.

A large class of dispersed pigments that will likely pass this salt stability test are those pigments that have been processed to be self-dispersing pigments (SDP's). However, SDP's do not meet the criteria of the instant invention in that no polymeric dispersant is included in the system. A test of an ink or dispersion to determine the presence of an SDP is as follows:
(a) Acidify the ink (or dispersion) by adding HCl. This converts the water solubilizing components on the SDP and dispersant, like COO⁻, SO₃⁻, phosphonate and the like, to their acidified form, thus lowering the solubility of the pigment and the dispersants in the aqueous media. Water-miscible cosolvent and surfactants should be dissolved into the aqueous phase by this step. Isolate the resulting solid. Alternatively, for a cationic-based ink, ammonia could be added to basify the cationic stabilizing group.
(b) Extract the resulting solid with tetrahydrofuran (THF). This removes binders and dispersants from the isolated solid, leaving a pigment substantially free of polymers. Encapsulants that are bound to the pigment may remain on the pigment.
(c) Dry the resulting solid.
(d) Redisperse the pigment with water and adjust the pH to about 9.
   (i) If the pigment redisperses into solution, then the pigment is an SDP where the dispersing moiety is covalently bound to the pigment particle.
   (ii) If pigment does not redisperse and remains undissolved, then it is not an SDP but a conventional pigment, which had been converted to a stable dispersion by the polymeric components that were removed in step (b).
(e) Dry the resulting solid.

In the case where the pigment is a mixture of SDP and conventional pigments with dispersants, such as described in previously incorporated U.S. Pat. No. 6,440,203, the pigment left at step (e) would likely be the conventional polymer dispersed pigment and the difference between the mass at step (c) and (e) would be the SDP that made up the pigment mixture.

The ISD polymer dispersants of the invention have dual functionality. The predominant portion is hydrophobic which has attractive forces to the pigment surface. The hydrophilic portion is limited such that the resultant pigment dispersant has little or no steric stabilization, and the resultant pigment/ISD polymer dispersant precipitates when tested by the salt stability test at 0.2 molar salt solutions.

The ISD polymers can be formed by reacting monomers with distinctly hydrophobic and hydrophilic properties. An example of these monomers would be acrylic and acrylate monomers and these are described below. Alternatively, the ISD nature of the polymeric dispersant can be a result of the reactions of other types of monomers. An example of this would be polyurethanes dispersants that satisfy the ISD salt stability criteria, where the advantageous balance of the hydrophobic and hydrophilic properties are likely derived from both the monomers used in the polyurethane synthesis and end capping moieties so that the resultant hydrophobic/hydrophilic balance in the final polyurethane product meets the above criteria.

The ISD polymer dispersants are prepared by polymerization of hydrophobic and hydrophilic monomers. There is no limit as to the means to polymerize these monomers, except that the final polymer, when tested as the polymeric dispersant with pigment, leads to a dispersion in which the resultant pigment/ISD polymer dispersant precipitates when tested by the salt stability test at 0.2 molar salt solution.

The ISD polymer dispersant may be a random, linear copolymer, or a structured polymer such as a diblock (A-B) or triblock (A-B-A or B-A-B) polymer, or a graft or branched polymer. The polymer can be made by any number of well-known polymerization processes, including free radical, ionic, group transfer (GTP), radical addition fragmentation (RAFT), atom transfer reaction (ATR), condensation reaction, etc. General conditions and examples of such polymerization processes are disclosed in many of the previously incorporated references.

The ISD polymer dispersants of the invention have dual functionality. The predominant portion is hydrophobic which has attractive forces to the pigment surface. The hydrophilic portion is limited such that the resultant pigment dispersant has little or no steric stabilization, and the resultant pigment/ISD polymer dispersant precipitates when tested by the salt stability test at 0.2 molar salt solutions.

The ISD polymers can be formed by reacting monomers with distinctly hydrophobic and hydrophilic properties. An example of these monomers would be acrylic and acrylate monomers and these are described below. Alternatively, the ISD nature of the polymeric dispersant can be a result of the reactions of monomers. An example of this would be polyurethanes dispersants that satisfy the ISD salt stability criteria, where the advantageous balance of the hydrophobic and hydrophilic properties are likely derived from both the monomers used in the polyurethane synthesis and the resultant hydrophobic/hydrophilic balance in the final polyurethane product.

Preferred ISD polymer dispersants are prepared by polymerization of hydrophobic and hydrophilic monomers such as acrylates and acrylics. There is no limit as to the means to polymerize these monomers, except that the final polymer, when tested as the polymeric dispersant with pigment, leads to a dispersion in which the resultant pigment/ISD polymer dispersant precipitates when tested by the salt stability test at 0.2 molar salt solution.

The ISD polymer dispersant derived from acrylic/acrylate monomers may be a random, linear copolymer, or a structured polymer such as a diblock (A-B) or triblock (A-B-A or B-A-B) polymer, or a graft or branched polymer. The polymer can be made by any number of well-known polymerization processes, including free radical, ionic, group transfer (GTP), radical addition fragmentation (RAFT), atom transfer reaction (ATR), etc. General conditions and examples of such polymerization processes are disclosed in many of the previously incorporated references.

The polymer dispersant derived from acrylic/acrylate monomers is a copolymer of hydrophobic and hydrophilic monomers. The precursor monomers can be denoted as follows, wherein A represents monomers for the hydrophobic segment, B represents monomers for the hydrophilic segment, Zₐ denotes a hydrophobic substituent on the A monomer, and Z_{b} denotes a hydrophilic substituent on the B monomer. One type of more than one type of monomer may be present in each segment.

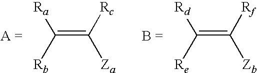

For A and B, preferred examples of structures that would result in ISD dispersants are those wherein each of R^{a}-R^{f} are independently selected from the group consisting of H and an alkyl, aryl or alkylaryl group having 1-20 carbons, and wherein Zₐ and Z_{b} are described below. In one preferred embodiment, each of R^{a}-R^{f} is selected from the group consisting of H and CH₃. In another preferred embodiment, each of R^{a}-R^{b} and R^{d}-R^{e} is H, and each of R^{c} and R^{f} is independently selected from H and CH₃.

The hydrophilic composition of ISD polymer dispersants is minimized relative to known polymeric dispersants as described in many of the previously incorporated references. The hydrophilicity of the ISD polymer dispersants is derived from the ionic substituent (Z_{b}) on the monomer B.

The Z_{b} group can be anionic, cationic, amphoteric or zwitterionic, hydrophilic components. Nonionic components can also be included in the polymeric dispersant as long as their inclusion does not lead to sufficient steric stabilization so that the polymeric dispersant with pigment does not meet the criteria set forth by the salt test. In the case of a polymer with non-ionic components, the salt test provides the means to determine what hydrophobic/hydrophilic/nonionic balance is required to obtain a ‘failed’ salt test at or below an ion concentration of 0.2 molar. Examples of the Z_{b} group include:
anionic, e.g., sulfonates, sulfates, sulfosuccinates, carboxylates, phosphates
cationic, e.g., amine salts, including quaternary amine salts.
amphoteric, e.g., N->O
zwitterionic, e.g., betaines, +N—C—CO₂—, lecithins.

The hydrophilic monomers may have single Z_{b} substituents or combinations of Z_{b} groups. The Z_{b} group is present as its hydrogen substituted form or as a salt.

Preferred hydrophilic monomers include, for example, methacrylic acid, acrylic acid, maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, vinyl pyrridine, N-vinyl pyrridine, and 2-acrylamido-2-propane sulfonic acid.

Other hydrophilic non-ionic monomers may be included. Preferred hydrophilic monomers include, for example, ethoxy triethyleneglycol methacrylate, hydroxyethyl methacrylate, hydroxypropyl methacrylate, 2-ethoxyethyl methacrylate, hydroxyethyl acrylate, and hydroxypropyl acrylate.

The hydrophobic composition of ISD polymer dispersants is maximized relative to known polymeric dispersants as described in many of the previously incorporated references. The hydrophobicity of the ISD polymer dispersants is derived from the hydrophobic substituent (Zₐ) on the monomer A.

In a preferred embodiment, Zₐis selected from the group consisting of:
(a) an alkyl, aryl and alkylaryl group containing 1-20 carbon atoms, which group may further contain one or more heteroatoms,
(b) a group of the structure C(O)OR⁹, wherein R⁹ is selected from the group consisting of an alkyl, aryl and alkylaryl group containing 1-20 carbon atoms, which group may further contain one or more heteroatoms, and
(c) a group of the structure C(O)NR^{h}Rⁱ, wherein each of R^{h} and Rⁱ is independently selected from the group consisting of H and an alkyl, aryl and alkylaryl group containing 1-20 carbon atoms, which group may further contain one or more heteroatoms.

Preferred hydrophobic monomers in general include, for example, benzyl methacrylate, butyl methacrylate, methyl methacrylate, ethyl methacrylate, propyl methacrylate, hexyl methacrylate, 2-ethylhexyl methacrylate, octyl methacrylate, lauryl ethacrylate, stearyl methacrylate, phenyl methacrylate, phenoxyethyl methacrylate, methacrylonitrile, glycidyl methacrylate, p-tolyl methacrylate, sorbyl methacrylate, methyl acrylate, ethyl acrylate, propyl acrylate, butyl acrylate, hexyl acrylate, 2-ethylhexyl acrylate, octyl acrylate, lauryl acrylate, stearyl acrylate, phenyl acrylate, phenoxyethyl acrylate, acrylonitrile, glycidyl acrylate, p-tolyl acrylate, sorbyl acrylate, styrene, alpha-methyl styrene, substituted styrenes, N-alkyl acrylamides, N-alkyl methacrylamides, vinyl acetate, vinyl butyrate and vinyl benzoate.

A preferred example of an A (hydrophobic) is an acrylic monomer, wherein Zₐ is selected from the group consisting of C(O)OR^{g}, C(O)NR^{h}Rⁱ and CN. In one preferred embodiment, R^{g} is selected from the group consisting of an alkyl, aryl and alkylaryl group having 1 to 20 carbon atoms, which group may further contain one or more heteroatoms; and R^{h} and Rⁱ are independently selected from the group consisting of H and an alkyl, aryl or alkylaryl group having 1 to 9 carbon atoms. Polymer segment of A monomers preferably have a number average molecular weight of at least about 300, and are water insoluble.

This list is not limiting in that any polymeric system which produces an ISD polymer dispersant (that is, which produces an ISD that satisfies the salt stability test) will satisfy the polymeric needs of the invention.

There are no limitations as to the polymerization methodology to combine monomers A and B to prepare the ISD polymeric dispersant. Examples of polymerization methods include but are not limited to free radical processes, Group Transfer Processes (GTP), and the like.

ISD polymer dispersant derived from acrylic/acrylate monomers preferred for use in the context of the present invention have a number average molecular weight greater than 300, preferably greater than 800, and below about 30,000, preferably below about 20,000, and typically in the range of about 1,000 to about 6,000.

ISD polymer dispersant derived from acrylic/acrylate monomers are limited to the amount of ionic content. For random, linear copolymer, diblock, graft and branched polymers, the limit of hydrophilic monomers is from about 1 mole percent to less than about 20 mole percent, based on all of the monomers. Alternatively, the limit of hydrophilic monomers is from about 2 mole percent to less than about 15 mole percent based on all of the monomers. For ABA triblocks, the limit is from about 2 mole percent to less than about 38 mole percent and, alternatively, less than about 25 mole percent. For BAB, triblocks the limit is from about 2 mole percent to less than about 25 mole percent. For each of these ionic limitations, the salt stability test of the pigment dispersion or ink jet ink is the determining factor relative to ionic content.

One of the results of the low hydrophilic content of the ISD polymeric dispersants derived from acrylic/acrylate monomers is that their solubility in water is low. Water, of course, is a preferred media for inkjet inks. Thus, in order to prepare a stable aqueous dispersions from the ISD polymer dispersants, the initial mixture of the pigment and the ISD polymer dispersants derived from acrylic/acrylate monomers preferably includes a water-miscible solvent, which sufficiently solubilizes the ISD polymer dispersant so that an initial physical mixture of the dispersant and pigment can be obtained. Then this ISD polymeric dispersant derived from acrylic/acrylate monomers, pigment and solvent mixture can be processed by conventional dispersion processing to form a stable ISD polymeric dispersant/pigment combination in an aqueous vehicle. This aqueous vehicle can thus be a combination of water and a water-miscible solvent. Candidate solvent systems can be determined by studying the solubility of the ISD polymeric dispersant derived from acrylic/acrylate monomers by using well-known solubility parameter methodologies.

Another preferred polymeric system for the ISD polymeric dispersants are urea terminated polyurethanes where the isocyanates, diols, and ionic constituent have been chosen to obtain a polyurethane capable of acting as a dispersant and meets the ISD criteria as determined by the salt stability test. The urea terminated polyurethanes described below where the ionic content is minimized result in urea terminated polyurethanes that satisfy this ISD criteria. The polyurethane ink additives described below, if the balance of properties satisfy the salt stability criteria, can be ISD dispersants.

The ISD's and ink compositions of the invention may be prepared by methods known in the art. It is generally desirable to make the ISD in a concentrated form, which is subsequently diluted with a suitable liquid containing the desired additives. The ISD is first prepared by premixing the selected pigment(s) and ISD polymeric dispersant(s) in an aqueous carrier medium (such as water and, optionally, a water-miscible solvent), and then dispersing or deflocculating the pigment. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ, and nylon. These various dispersion processes are in a general sense well-known in the art, as exemplified by, U.S. Pat. No. 5,022,592, U.S. Pat. No. 5,026,427, U.S. Pat. No. 5,310,778, U.S. Pat. No. 5,891,231, U.S. Pat. No. 5,679,138, U.S. Pat. No. 5,976,232 and US20030089277. All of these documents are incorporated by reference herein for all purposes as if fully set forth. Preferred are 2-roll mill, media mill, and by passing the mixture through a plurality of nozzles within a liquid jet interaction chamber at a liquid pressure of at least 5,000 psi.

After the milling process is complete the pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment. The determination of sufficient let down conditions is needed for all combinations of the polymeric dispersant, the solvent and the pigment.

After the ISD preparation, the amount of water-miscible solvent may be more than some ink jet applications will tolerate. For some of the ISDs, it thus may be necessary to ultrafilter the final dispersion to reduce the amount of water-miscible solvent. To improve stability and reduce the viscosity of the pigment dispersion, it may be heat treated by heating from about 30° C. to about 100° C., with the preferred temperature being about 70° C. for about 10 to about 24 hours. Longer heating does not affect the performance of the dispersion.

The amount of polymeric ISD dispersants required to stabilize the pigment is dependent upon the specific ISD dispersants, the pigment and vehicle interaction. The weight ratio of pigment to polymeric ISD dispersants will typically range from about 0.5 to about 6. A preferred range is about 0.75 to about 4.

While not being bound by theory, it is believed that the ISD's provide improved ink properties by the following means. Stable aqueous dispersions are critical for inkjet inks to assure long-lived ink cartridges and few problems with failed nozzles, etc. It is, however, desirable for the ink to become unstable as it is jetted onto the media so that the pigment in the ink “crashes out” onto the surface of the media (as opposed to being absorbed into the media). With the pigment on the surface of the media, beneficial properties of the ink can be obtained.

The ISD polymeric dispersants provide novel dispersants that sufficiently stabilize the ink prior to jetting (such as in the cartridge) but, as the ink is jetted onto the paper, the pigment system is destabilized and the pigment remains on the surface of the media. This leads to improved ink properties.

The hydrophobic nature of the inkjet inks made with ISD's improves optical density and chroma significantly. A recent discussion of pigmented ink in IS&T's NIP 18:2002 International Conference on Digital Printing Technologies, page 369, describes a hydrophobic pigment formulation that, when jetted onto a plain paper, results in the pigment residing on the paper surface. This surface deposit of pigment results in better optical density and chroma. The ISD's of this invention take the hydrophobicity to an even greater level to achieve even better combination of optical density, chroma, gloss and distinctness of image.

### Polyurethane Ink Additive

The polyurethane ink additive is a polyurethane which has urethane bonds in the main chains of the polyurethane structure. These polyurethanes may be soluble, or in a form of a colloidal dispersion, emulsion, suspension or a slurry.

The preferred form of the polyurethane ink additive is as a water dispersible polyurethane. In accordance with the present invention the term “polyurethane additive”

can refer to aqueous dispersions of polymers containing urethane groups and optionally urea groups, as that term is understood by those of ordinary skill in the art. These polymers also incorporate hydrophilic functionality to the extent required to maintain a stable dispersion of the polymer in water.

Preferred polyurethane ink additives are those in which the polymer is predominantly stabilized in the dispersion through incorporated ionic functionality, and particularly anionic functionality such as neutralized acid groups (“anionically stabilized polyurethane dispersion”). Further details are provided below.

Further preferred polyurethanes ink additives are those that are a.) urea terminated or b.) or crosslinked. The urea terminated polyurethane has a weight fraction of the urea-terminated polyurethane part of the polyurethane of at least 2 wt % to the urethane resin. The crosslinked polyurethane is present in the ink in the weight range of more than about 0.5% to about 30% by weight based on the total weight of the aqueous ink, and where the amount of crosslinking in the crosslinked polyurethane is greater than about 1% and less than about 50% as determined by the THF insolubles test.

Such aqueous polyurethane ink additives are typically prepared by a multi-step process in which an isocyanate (N═C═O, NCO) prepolymer which has excess NCO groups is initially formed and subsequently chain terminated with a monofunctional isocyanate reactive group, or chain extended in the aqueous phase optionally in the presence of a polyfunctional group chain extender. In the case of the polyfunctional group chain extender this will lead to crosslinking of the polyurethane additive. Also, the NCO prepolymer is typically formed by a multi-step process. For the urea terminated polyurethane it is the NCO prepolymer which is reacted with a primary or secondary amine to produce the urea termination of the polyurethane. Although other means of forming the crosslinked polyurethane are described below, the preferred crosslinked polyurethane also has the NCO prepolymer as a key intermediate which in turn is reacted with at least a trisubstituted secondary and/or primary amines to produce the crosslinking. During the crosslinking mono and disubstituted amines may be present with the trisubstituted crosslinker.

Typically, in the first stage of prepolymer formation, a diisocyanate is reacted with a compound containing one or more isocyanate-reactive groups and at least one acid or acid salt group to form an intermediate product. The acid or acid salt group may be a part of the diisocyanate compound or part of the compound containing the isocyanate reactive group. The molar ratio of the isocyanate groups to the isocyanate-reactive groups is such that the equivalents of isocyanate functionality is greater than the equivalents of isocyanate-reactive functionality, resulting in an intermediate product terminated by at least one NCO group. Thus, the molar ratio of isocyanate groups to

isocyanate-reactive groups is at least about 1.01 to 1.4:1, preferably 1.05 to 1. 25:1 and more preferably 1.1 to 1.15:1, As an example, diisocyanate are reactive with diols in the presence of diols with ionic groups to produce an isocyanate rich prepolymer which is then reacted further.

Suitable isocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well. Structure I, R1 can be preferably substituted with aliphatic groups.

Diisocyanates are preferred, and any diisocyanate useful in preparing polyurethanes and/or polyurethane-ureas from polyether glycols, diisocyanates and diols or amine can be used in this invention.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODI); Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are preferred.

Small amounts, preferably less than about 3 wt % based on the weight of the diisocyanate, of monoisocyanates or polyisocyanates can be used in mixture with the diisocyanate. Examples of useful monoisocyanates include alkyl isocyanates such as octadecyl isocyanate and aryl isocyanates such as phenyl isocyanate. Example of a polyisocyanate are triisocyanatotoluene HDI trimer (Desmodur 3300), and polymeric MDI (Mondur MR and MRS).

Isocyanate-reactive compounds containing acid groups, i.e., carboxylic acid groups, carboxylate groups, sulphonic acid groups, sulphonate groups, phosphoric acid groups and phosphonate groups, are chemically incorporated into the polyurethane to provide hydrophilicity and enable the polyurethane to be stably dispersed in an aqueous medium. The acid salts are formed by neutralizing the corresponding acid groups either prior to, during or after formation of the NCO prepolymer, preferably after formation of the NCO prepolymer. Isocyanate reactive compounds containing carboxylic acids or carboxylic acid salts are preferred.

Suitable compounds for incorporating carboxyl groups are described in U.S. Pat. No. 3,479,310, U.S. Pat. No. 4,108,814 and U.S. Pat. No. 4,408,008, which are incorporated by reference herein for all purposes as if fully set forth. The neutralizing agents for converting the carboxylic acid groups to carboxylate salt groups are described in the preceding U.S. patents and are also discussed hereinafter. Within the context of this invention, the term “neutralizing agents” is meant to embrace all types of agents which are useful for converting carboxylic acid groups to hydrophilic carboxylate salt groups.

Preferred carboxylic group-containing compounds are the hydroxy-carboxylic acids corresponding to the structure (HO)ⱼQ(COOH)ₖ wherein Q represents a straight or branched, hydrocarbon radical containing 1 to 12 carbon atoms, j is 1 or 2, preferably 2 and k is 1 to 3, preferably 1 or 2 and more preferably 1.

Examples of these hydroxy-carboxylic acids include citric acid, tartaric acid and hydroxypivalic acid. Especially preferred acids are those of the above-mentioned structure wherein j=2 and k=1. These dihydroxy alkanoic acids are described in U.S. Pat. No. 3,412,054, which is incorporated by reference herein for all purposes as if fully set forth. Especially preferred dihydroxy alkanoic acids are the alpha, alpha-dimethylol alkanoic acids represented by the structural formula:

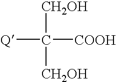

wherein Q′ is hydrogen or an alkyl group containing 1 to 8 carbon atoms. The most preferred compound is alpha, alpha-dimethylol propionic acid, i.e., wherein Q′ is methyl in the above formula.

The acid groups are incorporated in an amount sufficient to provide an ionic group content of at least about 10, preferably at least about 18 milligrams of KOH/gram of polyurethane resin solids The upper limit for the content of acid groups is about 100, preferably about 60, and more preferably about 40 milligrams per 1 g of polyurethane resins solids. This ionic group content is equivalent to an acid number for the polyurethane resin solids.

Isocyanate reactive group compounds include polyols, especially diols. Suitable polyols containing at least two hydroxy groups, which may be reacted with the preadducts to prepare the NCO prepolymers, are those having a molecular weight of about 120 to about 6000, preferably about 400 to about 3000, and more preferably about 600 to about 2500. The molecular weights are number average molecular weights (Mn) and are determined by end group analysis (OH number, hydroxyl analysis). Examples of these high molecular weight compounds include polyester polyols, polyether polyols, polyhydroxy polycarbonates, polyhydroxy polyacetals, polyhydroxy polyacrylates, polyhydroxy polyester amides and polyhydroxy polythioethers. A combination of the polyols can also be used in the polyurethane.

Suitable polyester polyols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids may be aliphatic, cycloaliphatic, aromatic and/or heterocyclic and they may be substituted, for example, by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

Suitable polyhydric alcohols include, e.g., enthylene glycol; propylene glycol-(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; triethylene glycol; tetra-ethylene glycol; polyethylene glycol; dipropylene glycol; polypropylene glycol; dibutylene glycol and polybutylene glycol, glycerine and trimethylol-propane.

The polyesters may also contain a portion of carboxyl end groups. Polyesters of lactones, for example, epsilon-caprolactone, or hydroxycarboxylic acids, for example, omega-hydroxycaproic acid, may also be used.

Polycarbonates containing hydroxyl groups include those known, per se, such as the products obtained from the reaction of diols such as propanediol-(1,3), butanediol-(1,4) and/or hexanediol-(1,6), diethylene glycol, triethylene glycol or tetraethylene glycol with phosgene, diarylcarbonates such as diphenylcarbonate or with cyclic carbonates such as ethylene or propylene carbonate. Also suitable are polyester carbonates obtained from the above-mentioned polyesters or polylactones with phosgene, diaryl carbonates or cyclic carbonates. Suitable polyether polyols are obtained in known manner by the reaction of starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. More preferably, polyethers obtained without the addition of ethylene oxide are used. Suitable starting compounds containing reactive hydrogen atoms include the polyhydric alcohols set forth for preparing the polyester polyols and, in addition, water, methanol, ethanol, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- or 1,1,2-tris-(hydroxylphenyl)ethane.

A preferred polyether diol is derived from 1,3-propanediol (PO3G). The employed PO3G may be obtained by any of the various well known chemical routes or by biochemical transformation routes. Preferably, the 1,3-propanediol is obtained biochemically from a renewable source (“biologically-derived” 1,3-propanediol). The description of this biochemically obtained 1,3-propanediol can be found in co-owned and co-pending U.S. patent application Ser. No. 11/782,098 (filed Jul. 24, 2007), the disclosure of which is incorporated by reference herein for all purposes as if fully set forth.

Polyethers which have been obtained by the reaction of starting compounds containing amine compounds can also be used, but are less preferred for use in the present invention. Examples of these polyethers as well as suitable polyhydroxy polyacetals, polyhydroxy polyacrylates, polyhydroxy polyester amides, polyhydroxy polyamides and polyhydroxy polythioethers are disclosed in U.S. Pat. No. 4,701,480, which is incorporated by reference herein for all purposes as if fully set forth.

Poly(meth)acrylates containing hydroxyl groups include those common in the art of addition polymerization such as cationic, anionic and radical, polymerization and the like. Preferred are alpha-omega diols. An example of these type of diols are those which are prepared by a “living” or “control” or chain transfer polymerization processes which enables the placement of one hydroxyl group at or near the termini of the polymer. U.S. Pat. No. 6,248,839 and U.S. Pat. No. 5,990,245 (both incorporated by reference herein for all purposes as if fully set forth) have examples of protocol for making terminal diols.

Other optional compounds for preparing the NCO prepolymer include low molecular weight, at least difunctional isocyanate-reactive compounds having an average molecular weight of up to about 400. Examples include the dihydric and higher functionality alcohols, which have previously been described for the preparation of the polyester polyols and polyether polyols.

In addition to the above-mentioned components which are preferably difunctional in the isocyanate polyaddition reaction, mono-functional and even small portions of trifunctional and higher functional components generally known in polyurethane chemistry, such as trimethylolpropane or 4-isocyananto-methyl-1,8-octamethylene diisocyanate, may be used in special cases in which slight branching of the NCO prepolymer or polyurethane is desired. However, the NCO prepolymers should be substantially linear and this may be achieved by maintaining the average functionality of the prepolymer starting components at or below 2:1.

Other optional compounds include isocyanate-reactive compounds containing lateral or terminal, hydrophilic ethylene oxide units. The content of hydrophilic ethylene oxide units (when present) may be up to about 50%, preferably up to about 40%, by weight, based on the weight of the polyurethane.

Other optional compounds include isocyanate-reactive compounds containing self-condensing moieties. The content of these compounds are dependent upon the desired level of self-condensation necessary to provide the desirable resin properties. 3-amino-1-triethoxysilyl-propane is an example on a compound that will react with isocyanates through the amino group and yet self-condense through the silyl group when inverted into water.

Non-condensable silanes with isocyanate reactive groups can be used in place of or in conjunction with the isocyanate-reactive compounds containing self-condensing moieties. U.S. Pat. No. 5,760,123 and U.S. Pat. No. 6,046,295 (both incorporated by reference herein for all purposes as if fully set forth) are exemplary methods for use of these optional silane containing compounds.

Process conditions for preparing the NCO prepolymers have been discussed in the patents previously incorporated by reference. The finished NCO prepolymer should have a free isocyanate content of about 0.5 to about 20%, preferably about 1 to about 10% by weight, based on the weight of prepolymer solids.

The polyurethanes can be prepared by chain extending these NCO prepolymers. Chain extenders include polyamine chain extenders, which can optionally be partially or wholly blocked as disclosed in U.S. Pat. No. 4,269,748 and U.S. Pat. No. 4,829,122, which are herein incorporated by reference herein for all purposes as if fully set forth. These patents disclose the preparation of aqueous polyurethane dispersions by mixing NCO prepolymers with at least partially blocked, diamine or hydrazine chain extenders in the absence of water and then adding the mixture to water. Upon contact with water the blocking agent is released and the resulting unblocked polyamine reacts with the NCO prepolymer to form the polyurethane.

Suitable blocked amines and hydrazines include the reaction products of polyamines with ketones and aldehydes to form ketimines and aldimines, and the reaction of hydrazine with ketones and aldehydes to form ketazines, aldazines, ketone hydrazones and aldehyde hydrazones. The at least partially blocked polyamines contain at most one primary or secondary amino group and at least one blocked primary or secondary amino group which releases a free primary or secondary amino group in the presence of water.

Suitable polyamines for preparing the at least partially blocked polyamines have an average functionality, i.e., the number of amine nitrogens per molecule, of 2 to 6, preferably 2 to 4 and more preferably 2 to 3. The desired functionalities can be obtained by using mixtures of polyamines containing primary or secondary amino groups. The polyamines are generally aromatic, aliphatic or alicyclic amines and contain from 1 to 30, preferably 2 to 15 and more preferably 2 to 10 carbon atoms. These polyamines may contain additional substituents provided that they are not as reactive with isocyanate groups as the primary or secondary amines. These same polyamines can be partially or wholly blocked polyamines.

Preferred polyamines used for chain extension and/or crosslinking include 1-amino-3-aminomethyl-3,5,5-trimethylcyclohexane isophorone diamine or IPDA, bis-(4-amino-cyclohexyl)-methane, bis-(4-amino-3-methylcyclohexyl)-methane, 1,6-diaminohexane, ethylene diamine, diethylene triamine, triethylene tetramine, tetraethylene pentamine and pentaethylene hexamine.

When a chain extender is used to react the excess NCO groups of the prepolymer, the amount of chain extender to be used in accordance with the present invention is dependent upon the number of terminal isocyanate groups in the prepolymer. Preferably, the ratio of terminal isocyanate groups of the prepolymer to isocyanate-reactive groups of the chain extender is between about 1.0:0.6 and about 1.0:1.1, more preferably between about 1.0:0.8 and about 1.0:0.98, on an equivalent basis. Any isocyanate groups that are not chain extended with an amine will react with water, which functions as a diamine chain extender.

Chain extension can take place prior to addition of water in the process, but typically takes place by combining the NCO prepolymer, chain extender, water and other optional components under agitation.

Polyurethanes can be characterized by a variety of techniques. One technique is differential scanning calorimetry analyses. This method characterizes thermal transitions of the polyurethanes. The initial T_{g} is a characteristic feature of a polyurethane.

Suitable polyurethane additives, when mixed with water or in the aqueous solution that the polyurethane was prepared, will form dispersion. The particle size of the polyurethane additives is typically in the range of about 30 to about 100,000 nm. The preferred range for polyurethane additives for inkjet inks is from about 30 to about 350 nm.

Other monomers and/or oligomers that will not participate chemically in the polyurethane synthesis steps can be added. The addition can be anywhere in the synthetic cycle as long as there is no interference in the polyurethane synthesis. A specific example of a compatible oligomer/monomer is a styrene allyl alcohol.

In order to have a stable polyurethane dispersion, a sufficient amount of the acid groups must be neutralized so that, when combined with the optional hydrophilic ethylene oxide units and optional external emulsifiers, the resulting polyurethane will remain stably dispersed in the aqueous medium. Generally, at least about 75%, preferably at least about 90%, of the acid groups are neutralized to the corresponding carboxylate salt groups. The preferred dispersion stabilization means for the polyurethane additives is the carboxylate groups, without ethylene oxide substituents and without external emulsifiers.

Suitable neutralizing agents for converting the acid groups to salt groups either before, during or after their incorporation into the NCO prepolymers, include tertiary amines, alkali metal cations and ammonia. Examples of these neutralizing agents are disclosed in U.S. Pat. No. 4,501,852 and U.S. Pat. No. 4,701,480, both of which are incorporated by reference herein for all purposes as if fully set forth.

Neutralization may take place at any point in the process. A typical procedure includes at least some neutralization of the prepolymer, which is then chain extended in water in the presence of additional neutralizing agent.

The preferred polyurethanes in additives are selected from a) urea terminated polyurethanes and b) crosslinked polyurethanes.

### Urea Terminated Polyurethanes Additives

An optional polyurethane ink additive can be a urea terminated polyurethane of general structure (I).

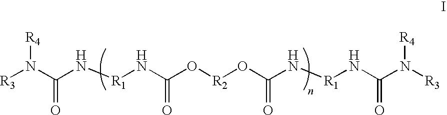

R₁=alkyl, substituted alkyl, substituted alkyl/aryl from a diisocyanate,
R₂=alkyl, substituted/branched alkyl from a diol,
R₃=hydrogen; alkyl; a non-isocyanate reactive substituted, isocyanate reactive substituted, or branched alkyl from the amine terminating group;
R₄=hydrogen; alkyl; a non-isocyanate reactive substituted, isocyanate reactive substituted, or branched alkyl from the amine terminating group;
where the isocyanate reactive group is selected from hydroxyl, carboxyl, mercapto, or amido;
n=2 to 30;
and where R₂=Z₁, Z₂ or Z₃ and at least one Z₁ or Z₃ and at least one Z₂ must be present in the polyurethane composition;

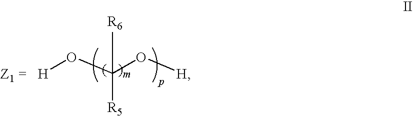

p greater than or equal to 1,
when p=l, m greater than or equal to 2 to about 36,
when p=2 or greater, m greater than or equal to 2 to about 12;
R₅, R₆=hydrogen, alkyl, substituted alkyl, aryl; where the R₅ is the same or different with each R₅ and R₆ substituted methylene group where R₅ and R₅ or R₆ can be joined to form a cyclic structure;
Z₂ is a diol substituted with an ionic group;
Z₃ is selected from polyester diols, polycarbonate diols, polyestercarbonate diols and polyacrylate diols;
   wherein the urea content of the urea terminated polyurethane ink additive is at least 2 wt % of the polyurethane resin.

Structure I denotes the urea terminated polyurethane ink additive and Structure II denotes the diol and polyether diol that is a building block for Structure I. When p is 1 a diol is the primary isocyanate reactive group and when p is greater than one the diol is characterized as a polyether diol.

The first step in the preparation is the preparation is the method of preparing an aqueous dispersion of an aqueous polyurethane composition of a urea terminated polyurethane comprising the steps:

(a) providing reactants comprising (i) at least one polyether diol Z₁ or Z₃ component comprising a diol, (ii) at least one polyisocyanate component comprising a diisocyanate, and (iii) at least one hydrophilic reactant comprising at least one isocyanate reactive ingredient containing an ionic group, Z₂,

(b) reacting (i), (ii) and (iii) in the presence of a water-miscible organic solvent to form an isocyanate-functional polyurethane prepolymer;

(c) adding water to form an aqueous dispersion; and

(d) prior to, concurrently with or subsequent to step (c), chain-terminating the isocyanate-functional prepolymer with a primary or secondary amine.

The chain terminating amine is typically added prior to addition of water in an amount to react with substantially any remaining isocyanate functionality. The chain terminating amine is preferably a nonionic secondary amine.

If the hydrophilic reactant contains ionizable groups then, at the time of addition of water (step (c)), the ionizable groups may be ionized by adding acid or base (depending on the type of ionizable group) in an amount such that the polyurethane can be stably dispersed. This neutralization can occur at any convenient time during the preparation of the polyurethane.

Preferably, at some point during the reaction (generally after addition of water and after chain extension), the organic solvent is substantially removed under vacuum to produce an essentially solvent-free dispersion.

After the polyurethane dispersion is prepared it is used in the dispersion of particles by known dispersion techniques. The key features of the polyurethane ink additive are the diol and/or at least one polyether diol, Z₁ or Z₃ and the monofunctional amine which results in the urea termination.

It should be understood that the process of used to prepare the polyurethane generally results in a urea-terminated polyurethane polymer of the above structure being present in the final product. However, it is understood that the final product will typically be a mixture of products, of which a portion is the above urea terminated polyurethane polymer, the other portion being a normal distribution of other polymer products and may contain varying ratios of unreacted monomers. The heterogeneity of the resultant polymer will depend on the reactants selected and reactant conditions chosen, as will be apparent to those skilled in the art.

### Diol and Polyether Diol Component of the Urea Terminated Polyurethane Ink Additive

The optional diol component {Z₁} can either be based on alpha, omega dialcohol or diols (p=1) with at least at least 2 methylene group and less than or equal to 30 methylene groups (m=2 to about 30) or a polyether diol (p is greater than 1) with 2 to 12 methylene groups (m=2 to about 12). The diol and polyether diol can be used separately or in mixtures. The amount of diol:polyether diol ranges from 0:100 to 100:0. The preferred number of methylene groups for the diol and polyetherdiol is at least 3 but less than about 30.

In one embodiment, the diol and/or polyether diol shown in Structure (II) may be blended with other oligomeric and/or polymer polyfunctional isocyanate-reactive compounds such as, for example, polyols, polyamines, polythiols, polythioamines, polyhydroxythiols and polyhydroxylamines. When blended, it is preferred to use di-functional components and, more preferably, one or more diols including, for example, polyether diols, polyester diols, polycarbonate diols, polyacrylate diols, polyolefin diols and silicone diols.

When p is greater than 1 the polyether diol shown in Structure (II) are oligomers and polymers in which at least 50% of the repeating units have 2 to 12 methylene groups in the ether chemical groups. More preferably from about 75% to 100%, still more preferably from about 90% to 100%, and even more preferably from about 99% to 100%, of the repeating units are 2 to 12 methylene groups in the ether chemical groups (in Structure (II) m=3-12). The preferable number of methylene groups are 3 or 4. The polyether diol shown in Structure (II) can be prepared by polycondensation of monomers comprising alpha, omega diols where m=2-12. Thus resulting in polymers or copolymers containing the structural linkage shown above. As indicated above, at least 50% of the repeating units are 2 to 12 methylene ether units.

The oligomers and polymers based on the polyether diol {where p is greater than 1} shown in Structure (II), has from 2 to about 50 of the polyether diols shown in Structure (II), repeating unit, more preferable about 5 to about 20 polyether diols shown in Structure (II). Where p denotes the number of repeating groups. R₅ and R₆ are hydrogen, alkyl, substituted alkyl, aryl; where the R₅ is the same or different with each R₅ and R₆ substituted methylene group and where R₅ and R₅ or R₆ can be joined to form a cyclic structure. The substituted alkyl preferably do not contain isocyanate reactive groups except as described below where a limited amount of trihydric alcohols can be allowed. In general, the substituted alkyls are intended to be inert during the polyurethane preparation.

In addition to the 3 to 12 methylene ether units, lesser amounts of other units, such as other polyalkylene ether repeating units derived from ethylene oxide and propylene oxide may be present. The amount of the ethylene glycols and 1.2-propylene glycols which are derived from epoxides such as ethylene oxide, propylene oxide, butylene oxide, etc are limited to less than 10% of the total polyether diol weight.

A preferred polyether diol is derived from 1,3-propanediol, (PO3G). The employed PO3G may be obtained by any of the various well known chemical routes or by biochemical transformation routes. Preferably, the 1,3-propanediol is obtained biochemically from a renewable source (“biologically-derived” 1,3-propanediol). The description of this biochemically obtained 1,3-propanediol can be found in co owned filed US Patent Application, with owner's identification as CL3026) the disclosure of which is incorporated by reference herein for all purposes as if fully set forth For the diol of Structure (II) (p=1) the biochemically derived material described above is the preferred 1,3-propanediol.

The starting material for making the diol will depend on the desired polyether diol of Structure II (p is greater than 1), availability of starting materials, catalysts, equipment, etc., and comprises “1,2 to 1,12-diol reactant.” By “1,2 to 1,12-diol reactant” is meant 1,2 to 1,12-diol, and oligomers and prepolymers of 1,3 to 1,12-diol preferably having a degree of polymerization of 2 to 50, and mixtures thereof. In some instances, it may be desirable to use up to 10% or more of low molecular weight oligomers where they are available. Thus, preferably the starting material comprises 1,3 to 1,12-diol and the dimer and trimer thereof. A particularly preferred starting material is comprised of about 90% by weight or more 1,3 to 1,12-diol, and more preferably 99% by weight or more 1,3 to 1,12-diol, based on the weight of the 1,3 to 1,12-diol reactant.

As indicated above, the polyether diol shown in Structure (II) (p greater than 1) may contain lesser amounts of other polyalkylene ether repeating units in addition to the 3-12 methylene ether units. The monomers for use in preparing poly(3-12)methylene ether glycol can, therefore, contain up to 50% by weight (preferably about 20 wt % or less, more preferably about 10 wt % or less, and still more preferably about 2 wt % or less), of comonomer diols in addition to the 1,3-propanediol reactant. Comonomer diols that are suitable for use in the process include aliphatic diols, for example, ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol; cycloaliphatic diols, for example, 1,4-cyclohexanediol, 1,4-cyclohexanedimethanol and isosorbide; and polyhydroxy compounds, for example, glycerol, trimethylolpropane, and pentaerythritol. The polyether diol shown in Structure (II) useful in practicing this invention can contain small amounts of other repeat units, for example, from aliphatic or aromatic diacids or diesters, such as described in U.S. Pat. No. 6,608,168 (the disclosure of which is incorporated by reference herein for all purposes as if fully set forth). This type of the polyether diol shown in Structure (II) can also be called a “random polymethylene ether ester”, and can be prepared by polycondensation of 1,3 to 1,12-diol reactant and about 10 to about 0.1 mole % of aliphatic or aromatic diacid or esters thereof, such as terephthalic acid, isophthalic acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, and combinations thereof, and dimethyl terephthalate, bibenzoate, isophthlate, naphthalate and phthalate; and combinations thereof. Of these, terephthalic acid, dimethyl terephthalate and dimethyl isophthalate are preferred.

When the polyether diol shown in Structure (II) (p is greater than 1) is used for the diol of the invention it preferable has a number average molecular weight (Mₙ) in the range of about 200 to about 5000, and more preferably from about 240 to about 3600. Blends of, the polyether diol shown in Structure (II) s can also be used. For example, the polyether diol shown in Structure (II) can comprise a blend of a higher and a lower molecular weight, the polyether diol shown in Structure (II) preferably wherein the higher molecular weight, the polyether diol shown in Structure (II) has a number average molecular weight of from about 1000 to about 5000, and the lower molecular weight, the polyether diol shown in Structure (II) has a number average molecular weight of from about 200 to about 750. The Mₙ of the blended, the polyether diol shown in Structure (II) will preferably still be in the range of from about 250 to about 3600. The, the polyether diol shown in Structure (II) s preferred for use herein are typically polydisperse polymers having a polydispersity (i.e. M_{w}/Mₙ) of preferably from about 1.0 to about 2.2, more preferably from about 1.2 to about 2.2, and still more preferably from about 1.5 to about 2.1. The polydispersity can be adjusted by using blends of, the polyether diol shown in Structure (II).

The polyether diol shown in Structure (II) for use in the present invention preferably have a color value of less than about 100 APHA, and more preferably less than about 50 APHA.

### Other Isocyanate-Reactive Components

As indicated above, the polyether diol shown in Structure (II) may be blended with other polyfunctional isocyanate-reactive components, most notably oligomeric and/or polymeric polyols.

Suitable other diols contain at least two hydroxyl groups, and preferably have a molecular weight of from about 60 to about 6000. Of these, the polymeric other diols are best defined by the number average molecular weight, and can range from about 200 to about 6000, preferably from about 400 to about 3000, and more preferably from about 600 to about 2500. The molecular weights can be determined by hydroxyl group analysis (OH number).

Examples of polymeric polyols include polyesters, polyethers, polycarbonates, polyacetals, poly(meth)acrylates, polyester amides, polythioethers and mixed polymers such as a polyester-polycarbonates where both ester and carbonate linkages are found in the same polymer. A combination of these polymers can also be used. For examples, a polyester polyol and a poly (meth)acrylate polyol may be used in the same polyurethane synthesis.

Suitable polyester polyols include reaction products of polyhydric, preferably dihydric alcohols to which trihydric alcohols may optionally be added, and polybasic (preferably dibasic) carboxylic acids. Trihydic alcohols are limited to at most about 2 weight % such that some branching can occur but no significant crosslinking would occur, and may be used in cases in which modest branching of the NCO prepolymer or polyurethane is desired. Instead of these polycarboxylic acids, the corresponding carboxylic acid anhydrides or polycarboxylic acid esters of lower alcohols or mixtures thereof may be used for preparing the polyesters.

The polycarboxylic acids may be aliphatic, cycloaliphatic, aromatic and/or heterocyclic or mixtures thereof and they may be substituted, for example, by halogen atoms, and/or unsaturated. The following are mentioned as examples: succinic acid; adipic acid; suberic acid; azelaic acid; sebacic acid; 1,12-dodecyldioic acid; phthalic acid; isophthalic acid; trimellitic acid; phthalic acid anhydride; tetrahydrophthalic acid anhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

Preferable polyester diols for blending with, the polyol shown in Structure (II) are hydroxyl terminated poly(butylene adipate), poly(butylene succinate), poly(ethylene adipate), poly(1,2-propylene adipate), poly(trimethylene adipate), poly(trimethylene succinate), polylactic acid ester diol and polycaprolactone diol. Other hydroxyl terminated polyester diols are copolyethers comprising repeat units derived from a diol and a sulfonated dicarboxylic acid and prepared as described in U.S. Pat. No. 6,316,586 (the disclosure of which is incorporated by reference herein for all purposes as if fully set forth). The preferred sulfonated dicarboxylic acid is 5-sulfo-isophthalic acid, and the preferred diol is 1,3-propanediol.

Suitable polyether polyols are obtained in a known manner by the reaction of starting compounds that contain reactive hydrogen atoms with alkylene oxides such as ethylene oxide, propylene oxide, butylene oxide, styrene oxide, tetrahydrofuran, epichlorohydrin or mixtures of these. It is preferred that the polyethers do not contain more than about 10% by weight of ethylene oxide units. More preferably, polyethers obtained without the addition of ethylene oxide are used. Suitable starting compounds containing reactive hydrogen atoms include the polyhydric alcohols set forth for preparing the polyester polyols and, in addition, water, methanol, ethanol, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- and 1,1,2-tris-(hydroxylphenyl)-ethane, dimethylolpropionic acid or dimethylolbutanoic acid.

Polyethers that have been obtained by the reaction of starting compounds containing amine compounds can also be used. Examples of these polyethers as well as suitable polyhydroxy polyacetals, polyhydroxy polyacrylates, polyhydroxy polyester amides, polyhydroxy polyamides and polyhydroxy polythioethers, are disclosed in U.S. Pat. No. 4,701,480 (the disclosure of which is incorporated by reference herein for all purposes as if fully set forth).

Polycarbonates containing hydroxyl groups include those known, per se, such as the products obtained from the reaction of diols such as propanediol-(1,3), butanediol-(1,4) and/or hexanediol-(1,6), diethylene glycol, triethylene glycol or tetraethylene glycol, higher polyether diols with phosgene, diarylcarbonates such as diphenylcarbonate, dialkylcarbonates such as diethylcarbonate or with cyclic carbonates such as ethylene or propylene carbonate. Also suitable are polyester carbonates obtained from the above-mentioned polyesters or polylactones with phosgene, diaryl carbonates, dialkyl carbonates or cyclic carbonates.

Polycarbonate diols for blending are preferably selected from the group consisting of polyethylene carbonate diol, polytrimethylene carbonate diol, polybutylene carbonate diol and polyhexylene carbonate.

Poly(meth)acrylates containing hydroxyl groups include those common in the art of addition polymerization such as cationic, anionic and radical polymerization and the like. Examples are alpha-omega diols. An example of these type of diols are those which are prepared by a “living” or “control” or chain transfer polymerization processes which enables the placement of one hydroxyl group at or near the termini of the polymer. U.S. Pat. No. 6,248,839 and U.S. Pat. No. 5,990,245 (the disclosures of which are incorporated by reference herein for all purposes as if fully set forth) have examples of protocol for making terminal diols. Other di-NCO reactive poly(meth)acrylate terminal polymers can be used. An example would be end groups other than hydroxyl such as amino or thiol, and may also include mixed end groups with hydroxyl.

An optional set of the diols are polyester diols, polycarbonate diols, polyestercartonate diols and polyacrylate diols as shown as Z₃ above. These Z₃ diols are always used in combination with Z₂ so that ionic properties of the polyurethane can be obtained.

Polyolefin diols are available from Shell as KRATON LIQUID L and Mitsubishi Chemical as POLYTAIL H.

Silicone glycols are well known, and representative examples are described in U.S. Pat. No. 4,647,643, the disclosure of which is incorporated by reference herein for all purposes as if fully set forth.

Other optional compounds for preparing the NCO prepolymer include lower molecular weight, at least difunctional NCO-reactive compounds having an average molecular weight of up to about 400. Examples include the dihydric and higher functional alcohols, which have previously been described for the preparation of the polyester polyols and polyether polyols.

In addition to the above-mentioned components, which are preferably difunctional in the isocyanate polyaddition reaction, mono-functional and even small portions of trifunctional and higher functional components generally known in polyurethane chemistry, such as trimethylolpropane or 4-isocyanantomethyl-1,8-octamethylene diisocyanate, may be used in cases in which branching of the NCO prepolymer or polyurethane is desired.

It is, however, preferred that the NCO-functional prepolymers should be substantially linear, and this may be achieved by maintaining the average functionality of the prepolymer starting components at or below 2.1.

Similar NCO reactive materials can be used as described for hydroxy containing compounds and polymers, but which contain other NCO reactive groups. Examples would be dithiols, diamines, thioamines and even hydroxythiols and hydroxylamines. These can either be compounds or polymers with the molecular weights or number average molecular weights as described for the polyols.

### Chain Termination Reactant for the Urea Terminated Polyurethane Additive

The terminating agent is a primary or secondary monoamine which is added to make the urea termination. In Structure (I) the terminating agent is shown as R₃ (R₄) N— substituent on the polyurethane. The substitution pattern for R₃ and R₄ include hydrogen, alkyl, a substituted/branched alkyl, isocyanate reactive where the substituent can be a isocyanate reactive group selected from hydroxyl, carboxyl, mercapto, amido and other ones which have less isocyanate reactivity than primary or secondary amine. At least one of the R₃ and R₄ must be other than hydrogen. R₃ and R₄ may be connected to form a cyclic compound. The cyclic compound may be also have oxygen in a cyclic compound.

The amount of chain terminator employed should be approximately equivalent to the unreacted isocyanate groups in the prepolymer, The ratio of active hydrogens from amine in the chain terminator to isocyanate groups in the prepolymer preferably being in the range from about 1.0:1 to about 1.2:1, more preferably from about 1.0:1.1 to about 1.1:1, and still more preferably from about 1.0:1.05 to about 1.1:1, on an equivalent basis. Although any isocyanate groups that are not terminated with an amine can react with other isocyanate reactive functional group and water the ratios of chain termination to isocyanate group is chosen to assure urea termination. Amine termination of the polyurethane is avoided by the choice and amount of chain terminating agent leading to a urea terminated polyurethane which has improved molecular weight control and improved properties as a particle dispersant.

Aliphatic primary or secondary monoamines are preferred. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl) amine, diethylamine, bis(methoxyethyl)amine, N-methylstearyl amine, diethanolamine and N-methyl aniline. Other non ionic hydrophilic secondary amines include heterocyclic structures such as morpholine and similar secondary nitrogen heterocycles. A preferred isocyanate reactive chain terminator is bis (methoxyethyl) amine (BMEA). The bis(methoxyethyl) amine is part of a preferred class of urea terminating reactant where the substituents are non reactive in the isocyanate chemistry, but are nonionic hydrophilic groups. This nonionic hydrophilic group provides the urea terminated polyether diol polyurethane with more water compatible.

Any primary or secondary monoamines substituted with less isocyanate reactive groups may be used as chain terminators. Less isocyanate reactive groups could be hydroxyl, carboxyl, amide and mercapto. Example of monoamines useful as chain terminators include but are not restricted to monoethanolamine, 3-amino-1-propanol, isopropanolamine, N-ethylethanolamine, diisopropanolamine, 6-aminocaproic acid, 8-aminocaprylic acid, 3-aminoadipic acid, and lysine. Chain terminating agents may include those with two less isocyanate reactive groups such as glutamine. A preferred isocyanate reactive chain terminator is diethanolamine. The diethanolamine is part of a preferred class of urea terminating reactant where the substituents are hydroxyl functionalities which can provide improved pigment wetting. The relative reactivity of the amine versus the less isocyanate reactive group and the mole ratios of NCO and the chain terminating amine produce the urea terminated polyurethane.

The urea content of the urea terminated polyurethane in weight percent of the polyurethane is determined by dividing the mass of chain terminator by the sum of the other polyurethane components including the chain terminating agent. The urea content is from about 2 wt % to about 14 wt %. The urea content is preferably from about 2.5. wt % to about 10.5 wt %. The 2 wt % occurs when the polyether diols used are large, for instance Mₙ is greater than about 4000 and/or the molecular weight of the isocyanate is high.

### Polyisocyanate Component

Suitable polyisocyanates preferably diisocyanates have been described above.

### Ionic Reactants

The hydrophilic reactant contains ionic and/or ionizable groups (potentially ionic groups). Preferably, these reactants will contain one or two, more preferably two, isocyanate reactive groups, as well as at least one ionic or ionizable group. In the structural description of the urea terminated polyether polyurethane described herein the reactant containing the ionic group is designated as Z₂.

Examples of ionic dispersing groups include carboxylate groups (—COOM), phosphate groups (—OPO₃ M₂), phosphonate groups (—PO₃ M₂), sulfonate groups (—SO₃ M), quaternary ammonium groups (—NR₃ Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R can be independently an alkyl, aralkyl, aryl, or hydrogen. These ionic dispersing groups are typically located pendant from the polyurethane backbone.

The ionizable groups in general correspond to the ionic groups, except they are in the acid (such as carboxyl —COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the urea terminated polyurethane in an amount to provide an ionic group content (with neutralization as needed) sufficient to render the polyurethane dispersible in the aqueous medium of the dispersion. Typical ionic group content will range from about 10 up to about 210 milliequivalents (meq), preferably from about 20 to about 140 meq., per 100 g of polyurethane, and most preferably less than about 90 meq per 100 g of urea terminated polyurethane.

Suitable compounds for incorporating these groups include (1) monoisocyanates or diisocyanates which contain ionic and/or ionizable groups, and (2) compounds which contain both isocyanate reactive groups and ionic and/or ionizable groups. In the context of this disclosure, the term “isocyanate reactive groups” is taken to include groups well known to those of ordinary skill in the relevant art to react with isocyanates, and preferably hydroxyl, primary amino and secondary amino groups.

Examples of isocyanates that contain ionic or potentially ionic groups are sulfonated toluene diisocyanate and sulfonated diphenylmethanediisocyanate.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are preferred. Preferred examples of anionic groups include carboxylate and sulfonate groups. Preferred examples of cationic groups include quaternary ammonium groups and sulfonium groups.

The neutralizing agents for converting the ionizable groups to ionic groups are described in the preceding incorporated publications, and are also discussed hereinafter. Within the context of this invention, the term “neutralizing agents” is meant to embrace all types of agents that are useful for converting ionizable groups to the more hydrophilic ionic (salt) groups.

In the case of anionic group substitution, the groups can be carboxylic acid groups, carboxylate groups, sulphonic acid groups, sulphonate groups, phosphoric acid groups and phosphonate groups, The acid salts are formed by neutralizing the corresponding acid groups either prior to, during or after formation of the NCO prepolymer, preferably after formation of the NCO prepolymer.

Suitable compounds for incorporating carboxyl groups are described in U.S. Pat. No. 3,479,310, U.S. Pat. No. 4,108,814 and U.S. Pat. No. 4,408,008, which are incorporated by reference herein for all purposes as if fully set forth. The neutralizing agents for converting the carboxylic acid groups to carboxylate salt groups are described in the preceding U.S. patents and are also discussed hereinafter. Within the context of this invention, the term “neutralizing agents” is meant to embrace all types of agents which are useful for converting carboxylic acid groups to hydrophilic carboxylate salt groups.

Preferred carboxylic group-containing compounds are the hydroxy-carboxylic acids corresponding to the structure (HO)ⱼQ(COOH)ₖ wherein Q represents a straight or branched, hydrocarbon radical containing 1 to 12 carbon atoms, j is 1 or 2, preferably 2 and k is 1 to 3, preferably 1 or 2 and more preferably 1.

Examples of these hydroxy-carboxylic acids include citric acid, tartaric acid and hydroxypivalic acid. Especially preferred acids are those of the above-mentioned structure wherein j=2 and k=1. These dihydroxy alkanoic acids are described in U.S. Pat. No. 3,412,054, which is incorporated by reference herein for all purposes as if fully set forth. Especially preferred dihydroxy alkanoic acids are the alpha, alpha-dimethylol alkanoic acids represented by the structural formula:

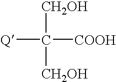

wherein Q′ is hydrogen or an alkyl group containing 1 to 8 carbon atoms. The most preferred compound is alpha,alpha-dimethylol propionic acid, i.e., wherein Q′ is methyl in the above formula.

When the ionic stabilizing groups are acids, the acid groups are incorporated in an amount sufficient to provide an acid group content for the urea-terminated polyurethane, known by those skilled in the art as acid number (mg KOH per gram solid polymer), of at least about 6, preferably at least about 10 milligrams KOH per 1.0 gram of polyurethane and even more preferred 20 milligrams KOH per 1.0 gram of polyurethane, The upper limit for the acid number (AN) is about 120, and preferably about 90.

The urea terminated polyurethane ink additive has a number average molecular weight of about 2000 to about 30,000. Preferably the molecular weight is about 3000 to 20000. As described here these urea terminated polyurethanes can also function as polymeric dispersants. In fact, those that have formulations that when used as dispersants and produce a pigments dispersion which passes the salt stability test shown above, can be considered ISD dispersants.

### Crosslinked Polyurethanes Ink Additives

An optional polyurethane ink additive can be a crosslinked polyurethane The means to achieve the crosslinking of the polyurethane generally relies on at least one component of the polyurethane (starting material and/or intermediate) having 3 or more functional reaction sites. Reaction of each of the 3 (or more) reaction sites will produce a crosslinked polyurethane (3-dimensional matrix). When only two reactive sites are available on each reactive components, only linear (albeit possibly high molecular weight) polyurethanes can be produced. Examples of crosslinking techniques include but are not limited to the following:

the isocyanate-reactive moiety has at least 3 reactive groups, for example polyfunctional amines or polyol;

the isocyanate has at least 3 isocyanate groups;

the prepolymer chain has at least 3 reactive sites that can react via reactions other than the isocyanate reaction, for example with amino trialkoxysilanes;

addition of a reactive component with at least 3 reactive sites to the polyurethane prior to its use in the inkjet ink preparations, for example tri-functional epoxy crosslinkers;

addition of a water-dispersible crosslinker with oxazoline functionality;

synthesis of a polyurethane with carbonyl functionality, followed by addition of a dihydrazide compound;

and any combination of the these crosslinking methods and other crosslinking means known to those of ordinary skill in the relevant art.

Also, it is understood that these crosslinking components may only be a (small) fraction of the total reactive functionality added to the polyurethane. For example, when polyfunctional amines are added, mono- and difunctional amines may also be present for reaction with the isocyanates. The polyfunctional amine may be a minor portion of the amines.

The crosslinking preferably occurs during the preparation of the polyurethane. A preferred time for the crosslinking in the polyurethane reaction sequence would be at or after the time of the inversion step. That is, crosslinking preferably occurs during the addition of water to the polyurethane preparation mixture or shortly thereafter. The inversion is that point where sufficient water is added such that the polyurethane is converted to its stable dispersed aqueous form. Most preferred is that the crosslinking occurs after the inversion. Furthermore, substantially all of the crosslinking of the polyurethane is preferably complete prior to its incorporation into the ink formulation.

Alternatively, the crosslinking can occur during the initial formation of the urethane bonds when the isocyanates or isocyanate-reactive groups have 3 or more groups capable of reacting. If the crosslinking is done at this early stage, the extent of crosslinking must not lead to gel formation. Too much crosslinking at this stage will prevent the formation of a stable polyurethane dispersion.

The amount of crosslinking of the polyurethane to achieve the desired inkjet ink for inkjet printing can vary over a broad range. While not being bound to theory, the amount of crosslinking is a function of the polyurethane composition, the whole sequence of reaction conditions utilized to form the polyurethane and other factors known to those of ordinary skill in the art.

The preferred crosslinking is done with a prepolymer with an excess of NCO reactive sites followed by reaction with amines of which at least some of the amines are trisubstituted or higher. After the inversion of the NCO-rich prepolymer amines are added to react with the excess NCOs. In addition to the trisubstituted amines monoamines and diamines may be present. The amines may be primary and secondary amines. A preferred amine mixture for the crosslinking is a mixture of diethylenetriamine and tetraethylenetriamine.

Based on techniques described herein, a person of ordinary skilled in the art is able to determine, via routine experimentation, the crosslinking needed for a particularly type of polyurethane to obtain an effective inkjet ink for textiles and other substrates. Furthermore, as indicated above, these inks may also be used for plain paper, photo paper, transparencies, vinyl and other printable substrates.

The amount of crosslinking can be measured by a standard tetrahydrofuran insolubles test. For the purposes of definition herein, the tetrahydrofuran (THF) insolubles of the polyurethane ink additive is measured by mixing 1 gram of the polyurethane ink additive with 30 grams of THF in a pre-weighed centrifuge tube. After the solution is centrifuged for 2 hours at 17,000 rpm, the top liquid layer is poured out and the non-dissolved gel in the bottom is left. The centrifuge tube with the non-dissolved gel is re-weighed after the tube is put in the oven and dried for 2 hours at 110° C.

% THF insolubles of polyurethane=(weight of tube and non-dissolved gel−weight of tube)/(sample weight*polyurethane solid %)

The upper limit of crosslinking is related to the ability to make a stable aqueous polyurethane dispersion. If a highly crosslinked polyurethane has adequate ionic or non-ionic functionality such that it is a stable when inverted into water, then its level of crosslinking will lead to an improved inkjet ink for textiles. The emulsion/dispersion stability of the crosslinked polyurethane can be improved by added dispersants or emulsifiers. The upper limit of crosslinking as measured by the THF insolubles test is about 90%. Alternatively the upper limit is about 50%.

The lower limit of crosslinking in the polyurethane ink additive is about 1% or greater, preferably about 4% or greater, as measured by the THF insolubles test.

An alternative way to achieve an effective amount of crosslinking in the polyurethane is to choose a polyurethane that has crosslinkable sites, then crosslink those sites via self-crosslinking and/or added crosslinking agents. Examples of self-crosslinking functionality includes, for example, silyl functionality (self-condensing) available from certain starting materials as indicated above, as well as combinations of reactive functionalities incorporated into the polyurethanes, such as epoxy/hydroxyl, epoxy/acid and isocyanate/hydroxyl. Examples of polyurethanes and complementary crosslinking agents include: (1) a polyurethane with isocyanate reactive sites (such as hydroxyl and/or amine groups) and an isocyanate crosslinking reactant, and 2) a polyurethane with unreacted isocyanate groups and an isocyanate-reactive crosslinking reactant (containing, for example, hydroxyl and/or amine groups). The complementary reactant can be added to the polyurethane, such that crosslinking can be done prior to its incorporation into an ink formulation. The crosslinking should preferably be substantially completed prior to the incorporation of the additive into the ink formulation. This crosslinked polyurethane preferably has from about 1% to about 50% crosslinking as measured by the THF insolubles test.

Combinations of two or more polyurethane additives of which one or more are crosslinked may also be utilized in the formulation of the ink.

Further details about the preparation of polyurethane dispersions can be found from the previously incorporated references.

The polyurethane ink additive is generally stable aqueous dispersion of polyurethane particles having a solids content of up to about 60% by weight, preferably about 15 to about 60% by weight and most preferably about 30 to about 45% by weight.

However, it is always possible to dilute the dispersions to any minimum solids content desired.

### Pigments

A wide variety of organic and inorganic pigments, alone or in combination, may be selected to make the ISDs and ink. The term “pigment” as used herein means an insoluble colorant and can include disperse dyes. The pigment particles are sufficiently small to permit free flow of the ink through the ink jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Preferably, the pigment particle size should range from about 0.005 to about 5 micron and, most preferably, from about 0.005 to about 1 micron. The average particle size as measured by dynamic light scattering is less than about 500 nm, preferably less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form. Representative commercial dry pigments are listed in U.S. Pat. No. 5,085,698 the disclosure of which are incorporated by reference herein for all purposes as if fully set forth

In the case of organic pigments, the ink may contain up to approximately 30%, preferably about 0.1 to about 25%, and more preferably about 0.25 to about 10%, pigment by weight based on the total ink weight. If an inorganic pigment is selected, the ink will tend to contain higher weight percentages of pigment than with comparable inks employing organic pigment, and may be as high as about 75% in some cases, since inorganic pigments generally have higher specific gravities than organic pigments.

The ISD polymer dispersant is preferably present in the range of about 0.1 to about 20%, more preferably in the range of about 0.2 to about 10%, and still more preferably in the range of about 0.25% to about 5%, by weight based on the weight of the total ink composition.

### Ink Preparation and Properties

The inks of the present invention are prepared by methods normally used to prepare ink jet inks. The ISD pigment dispersion and polyurethane ink additives are mixed together with other additives to obtain the ink jet ink. It is preferable to add the ingredients to the ISD pigment dispersion with agitation. The other ingredients can be added in any convenient order.

The dispersants used may also be used as ink additive. That is, a polyurethane similar or the same as the structure shown in Structure I can be used to disperse a pigment and also used as the polyurethane ink additive.

The polyurethane ink additive is present in the range of about 0.1 to about 12%, more preferably in the range of about 0.2 to about 10% and still more preferably in the range of the about 0.25 to about 8% by weight based on the weight of the total ink composition.

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as about 30 cP at 25° C., but is typically somewhat lower. The ink has physical properties that can be adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, lower viscosity inks can be used, and may be preferred for certain applications. Thus the viscosity (at 25° C.) of the inks can be less than about 7 cps, less than about 5 cps, or even less than about 3.5 cps.

### Aqueous Carrier Medium

The aqueous carrier medium (aqueous vehicle) is water or a mixture of water and at least one water-miscible organic solvent. Selection of a suitable mixture depends on requirements of the specific application, such as desired surface tension and viscosity, the selected pigment, drying time of the pigmented ink jet ink, and the type of paper onto which the ink will be printed. Representative examples of water-soluble organic solvents that may be selected include (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl)ether, diethylene glycol mono-methyl (or -ethyl)ether, propylene glycol mono-methyl (or -ethyl)ether, triethylene glycol mono-methyl (or -ethyl)ether and diethylene glycol di-methyl (or -ethyl)ether; (7) nitrogen containing cyclic compounds, such as pyrrolidone, N-methyl-2-pyrrolidone, and 1,3-dimethyl-2-imidazolidinone; 1,3-dihydroxyethyl dimethyl hydantoin and (8) sulfur-containing compounds such as dimethyl sulfoxide and tetramethylene sulfone.

A mixture of water and a polyhydric alcohol, such as diethylene glycol, is preferred as the aqueous carrier medium. In the case of a mixture of water and diethylene glycol, the aqueous carrier medium usually contains from about 30% water/70% diethylene glycol to about 95% water/5% diethylene glycol. The preferred ratios are approximately 60% water/40% diethylene glycol to about 95% water/5% diethylene glycol. Percentages are based on the total weight of the aqueous carrier medium. A mixture of water and butyl carbitol is also an effective aqueous carrier medium.

The amount of aqueous carrier medium in the ink is typically in the range of about 70% to about 99.8%, and preferably about 80% to about 99.8%, based on total weight of the ink.

The aqueous carrier medium can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether; ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® b series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

### Other Additives

Other additives, such as biocides, humectants, chelating agents and viscosity modifiers, may be added to the ink for conventional purposes.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Other polymer additives, if used, can be soluble or dispersed polymer(s) and can be use in addition to the polyurethane ink additive in the ink of the present invention. They can be any suitable polymer, for example, soluble polymers may include linear homopolymers, copolymers, block polymers or natural polymers. They also can be structured polymers including graft or branched polymers, stars, dendrimers, etc. The dispersed polymers can include latexes, etc. The polymers may be made by any known process including but not limited to free radical, group transfer, ionic, RAFT, condensation and other types of polymerization. Useful classes of polymers include, for example, acrylics, styrene-acrylics, and alginates. These other polymer additives can be chosen from polymers that are capable of functioning as ISD polymer dispersants, but are not utilized as such.

These polymer additives can be effective in improving jetting stability, storage stability of the ink prior to being put into a cartridge and stability in a cartridge. Other properties that can be affected by the polymer additives include, for example, reliability for thermal inkjet printing and image durability, including smear resistance.

### Ink Sets

Ink sets suitable for use with the present invention comprise at least three primary color inks: a cyan ink, a magenta ink and a yellow ink (CMY), wherein at least one (and preferably all three) of these inks are based on ISDs and the polyurethane ink additive. The ink set may optionally contain additional inks, and particularly a black ink (making a CMYK ink set).

When the ink set contains a black ink, pigment is generally preferred for black from the standpoint of high optical density. The black ink may be a dispersed carbon black using the ionically stabilized dispersants described herein. The polyurethane ink additive may also be present in the black ink. An optional black pigment is a carbon black pigment, and particularly an SDP black. Examples of SDP blacks and inks based thereon may be found, for example, U.S. Pat. No. 6,852,156 other SDP types referenced in U.S. Pat. No. 6,852,156 (the disclosures of which are incorporated by reference herein for all purposes as if fully set forth).

In addition to the black ink, the ink set may further include one or more other colored inks such as, for example, an orange ink and/or a green ink.

The ink set with the ISD dispersed pigment and the polyurethane ink additive may further comprise a fixing solution, which may be advantageous in reducing blurring and strikethrough in fast drying aqueous inks. See, for example, U.S. Pat. No. 5,746,818, U.S. Pat. No. 6,450,632, US20020044185, EP1258510 and US20040201658, the disclosures of which are incorporated by reference herein for all purposes as if fully set forth.

This invention now will be further illustrated, but not limited, by the following examples.

### EXAMPLES

### Ingredients and Abbreviations

BMEA=bis(methoxyethyl) amine
DBTL=dibutyltindilaurate
DMEA=dimethylethanolamine
DMIPA=dimethylisopropylamine
DMPA=dimethylol propionic acid
DMBA=dimethylol butyric acid
EDA=ethylene diamine
EDTA=ethylenediamine tetraacetic acid
HDI=1,6-hexamethylene diisocyanate
IPDI=isophoronediisocyanate
TMDI=trimethylhexamethylene diisocyanate
TMXDI=m-tetramethylene xylylene diisocyanate
NMP=n-Methyl pyrolidone
TEA=triethylamine
TEOA=triethanolamine
TETA=triethylenetetramine
THF=tetrahydrofuran
Tetraglyme=Tetraethylene glycol dimethyl ether

Unless otherwise noted, the above chemicals were obtained from Aldrich (Milwaukee, Wis.) or other similar suppliers of laboratory chemicals.

TERATHANE® D 650 is a 650 molecular weight, polytetramethylene ether glycol (PTMEG) from Invista, Wichita, Kans.

TERATHANE® 250 is a 250 molecular weight, polytetramethylene ether glycol

### Extent of Polyurethane Reaction

The extent of polyurethane reaction was determined by detecting NCO % by dibutylamine titration, a common method in urethane chemistry.

In this method, a sample of the NCO containing prepolymer is reacted with a known amount of dibutylamine solution and the residual amine is back titrated with HCl.

### Particle Size Measurements

The particle size for the polyurethane dispersions, pigments and the inks were determined by dynamic light scattering using a Microtrac® UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution.

The reported numbers below are the volume average particle size.

### Solid Content Measurement

Solid content for the solvent free polyurethane dispersions was measured with a moisture analyzer, model MA50 from Sartorius. For polyurethane dispersions containing high boiling solvent, such as NMP, tetraethylene glycol dimethyl ether, the solid content was then determined by the weight differences before and after baking in 150° C. oven for 180 minutes.

### MW Characterization of the Polyurethane Additive

All molecular weights were determined by GPC (gel permeation chromatography) using poly(methyl methacrylate) standards with tetrahydrofuran as the elutent. Using statics derived by Flory, the molecular weight of the polyurethane may be calculated or predicted based on the NCO/OH ratio and the molecular weight of the monomers Molecular weight is also a characteristic of the polyurethane that can be used to define a polyurethane. The molecular weight is routinely reported as number average molecular weight, Mw. For the urea terminated polyurethane ink additive the preferred molecular weight range is 2000 to 30000, or more preferable 3000 to 20000. For the crosslinked polyurethane ink additive, the preferred molecular weight is more than 30,000 as Mn. The polyurethane additives are not limited to Gaussian distribution of molecular weight, but may have other distributions such as bimodal distributions.

### Salt Stability Test

The procedure for testing polymeric dispersions and inks used in these Examples is described below.
(a) Prepare salt solutions by diluting a stock solution (for example a 0.2 molar NaCl) with deionized water.
(b) To a glass vial (19 mm×65 mm vials with caps), add 1.5 g (ml) of salt solution with a disposable transfer pipette. (Pipette used was a SAMCO Transfer Pipette, cat #336 B/B-PET, Samco Scientific Corp, San Fernando, Calif.).
(c) Add test solution with the transfer pipette. One drop is used for dispersion concentrates. Three drops are used for ink samples.
(d) Mix the vial thoroughly with gentle swirling.
(e) Allow mixture to sit, undisturbed, for 24 hours at room temperature.
(f) Record visual observation of each sample.
Rating of 3: complete settling of pigment; transparent, uncolored liquid at top.
Rating of 2: no transparent uncolored liquid layer; definite settling onto bottom of vial observed when vial is tilted.
Rating of 1: no transparent uncolored liquid layer; very slight settling (small isolated spots) as observed during tilting of vial.
Rating of 0: no evidence of any settling.

### THF Insolubles Measurement

THF insolubles content of the polyurethanes was measured by first mixing 1 gram of the polyurethane dispersoid with 30 grams of THF in a pre-weighed centrifuge tube. After the solution Was centrifuged for 2 hours at 17,000 rpm, the top liquid layer was poured out and the non-dissolved gel in the bottom was left. The centrifuge tube with the non-dissolved gel was re-weighed after the tube was put in the oven and dried for 2 hours at 110° C.

% Micro-gel of polyurethane=((weight of tube and non-dissolved gel)−(weight of tube))/(sample weight*polyurethane solid %).

### Polymeric Dispersants

The following synthetic examples were all based on group transfer polymerization (GTP), although other types of polymerization processes can be used to generate similar types of polymers. In the case of the block polymers, the current block was at least 95% converted before adding the mixture of monomers for the next block. In all cases, the feed cycle strategy is described. However, the synthesis was terminated when 99% of the polymer was converted as detected by HPLC. The molecular weight reported (unless otherwise noted) is based on theoretical considerations. For the random linear polymers, the ratio given is the weight ratio of the monomer unit in the final polymer; for the triblock and other polymers the ratio is the mole ratio of the monomer components.

Standard laboratory techniques were employed for the following examples.

The acid value was determined by titration and is reported as mg/gram of polymer solids. Molecular weight was determined by GPC. The GPC separations were carried out using a four column set consisting of two 500-Å, and two 100-Å 30 cm×7.8 mm i.d. Microstyragel columns (Waters, Milford, Mass.). The tetrahydrofuran mobile phase was delivered by a Hewlett-Packard (Palo Alto, Calif.) model 1090 gradient liquid chromatograph at a flowrate of 1.0 mL/min. The eluting species were detected using a Hewlett-Packard 1047A differential refractive detector. Narrow low-molecular-weight poly(methyl-methacrylate) standards were used as calibrants. The particle size was determined by dynamic light scattering using a Microtrac Analyzer, Largo Fla. For many of the dispersion steps, a Model 100 F or Y, Microfluidics System was used (Newton Mass.).

It should be noted that, in referring to the polymer compositions, a double slash indicates a separation between blocks and a single slash indicates a random copolymer. Thus, for example, BZMA/MAA 90/10 is a random copolymer having about 90 wt % benzyl methacrylate (BZMA) and about 10 wt % methacrylic acid (MAA) units in the final polymer; and BZMA//MAA//BZMA 8//10//8 is an ABA triblock polymer with a first A block that is on average 8 BZMA units long, a B block that is on average 10 MAA units long, and a final A block that is on average 8 BZMA units long.

### ISD Dispersant 1a BZMA/MAA 90/10 Random Linear Copolymer

A 5-liter flask was equipped with a mechanical stirrer, thermometer, N₂ inlet, drying tube outlet, and addition funnels. Tetrahydrofuran (THF), 1715.1 g, was charged to the flask. The catalyst (tetrabutyl ammonium m-chlorobenzoate, 1.2 ml of a 1.0 M solution in acetonitrile) was then added. Initiator (1-methoxy-1-trimethylsiloxy-2-methyl propene, 51.33 g (0.295 moles)) was injected. Feed I (tetrabutyl ammonium m-chlorobenzoate, 1.2 ml of a 1.0 M solution in acetonitrile and THF, 10.0 g) was started and added over 180 minutes. Feed II (trimethylsilyl methacrylate, 267.6 g (1.69 moles) and benzyl methacrylate (BZMA), 1305.6 g (7.42 moles)) was started at 0.0 minutes and added over 70 minutes.

At 173 minutes, 60.5 g of methanol was added to the above solution and distillation began. During the first stage of distillation, 503.0 g of material was removed. The final polymer solution was 51.5% solids.

The polymer had a composition of BZMA/MAA 90/10; molecular weight (Mn) of 5048; and an acid value of 1.24 (milliequivalents/gram of polymer solids) based on total solids:

### ISD Dispersant 1b BZMA/MAA 90/10 Random Linear Copolymer

A 3-liter flask was equipped with a mechanical stirrer, thermometer, N₂ inlet, drying tube outlet, and addition funnels. Tetrahydrofuran (THF), 1200 g, was charged to the flask. The catalyst (tetrabutyl ammonium m-chlorobenzoate, 0.75 ml of a 1.0 M solution in acetonitrile) was then added. Initiator (1,1-bis (trimethylsilyloxy)-2-methyl propene, 42.5 g (0.18 moles)) was injected. Feed I (tetrabutyl ammonium m-chlorobenzoate, 0.4 ml of a 1.0 M solution in acetonitrile and THF, 5 g) was started and added over 180 minutes. Feed II (trimethylsilyl methacrylate, 135.5 g (0.86 moles) and benzyl methacrylate, 825.5 g (4.69 moles)) was started at 0.0 minutes and added over 45 minutes.

At 125 minutes, 70 g of methanol was added to the above solution and distillation began. During the first stage of distillation, 375 g of material was removed. The final polymer solution was 48.5% solids.

The polymer had a composition of BZMA/MAA 90/10; molecular weight (Mn) of 4995, and an acid value of 1.22 (milliequivalents/gram of polymer solids) based on total solids.

### ISD Dispersant 2a BZMA/MAA 92/8 Random Linear Copolymer

The same preparation was used as in preparation 1a except 213.2 g of trimethylsilyl methacrylate and 1334.5 g of benzyl methacrylate were used. This resulted in a polymer solution of 51.7% solids, with a composition of BZMA/MAA 92/8, a molecular weight (Mn) of 5047 and an acid value of 0.99 (meq/gram of polymer solids.) based on total solids.

ISD Dispersant 2b BZMA/MAA 92/8 Random Linear Copolymer with 2-Pyrrolidone as Final Solvent

In a 5 liter flask, 1449 g of polymer 2a solution was added along with 412 g of 2-pyrrolidone. The solution was heated to reflux and 56 g of solvent was distilled off. Then 320.5 g of 2-pyrrolidone was added to make a polymer solution of 45.7% solids.

ISD Dispersant 2c BZMA/MAA 92/8 Random Linear Copolymer

The same preparation was used as in polymer preparation 1b except 103.0 g trimethylsilyl methacrylate (0.65 moles), 844 g benzyl methacrylate (4.80 moles) and 55 g methanol were used, and 354 g of material was removed. The final polymer solution was 48.4% solids.

The polymer had a composition of BZMA/MAA 92/8; molecular weight (Mn) of 4999, and an acid value of 0.98 (meq/gram of polymer solids) based on total solids.

ISD Dispersant 2d Neutralization of Polymer 2b with Potassium Hydroxide

The following ingredients were combined with stirring:

| INGREDIENT | AMOUNT (G) |
|---|---|
| Polymer preparation 2b | 33.0 |
| 45% aqueous potassium hydroxide solution | 4.4 |
| D.I. Water | 63.1 |

In a 2 liter flask, 1000 g of polymer la solution was added. The solution was heated to reflux and 284 g of solvent was distilled off. Then 221 g of 2-pyrrolidone was added to the flask. After another 156 g of solvent was distilled off, 266 g of 2-pyrrolidone was added to make a polymer solution of 47% solids.

### ISD Dispersant 3a BZMA/MAA 94/6 Random Linear Copolymer

The same preparation was used as in preparation 1a except 160.3 g of trimethylsilyl methacrylate and 1363.5 g of benzyl methacrylate were used. The result was of 49.9% solids polymer solution with a composition of BZMA/MAA 94/6, a molecular weight (Mn) of 5047, and an acid value of 0.77 (meq/gram of polymer solids.) based on total solids.

ISD Dispersant 3b BZMA/MAA 94/6 Random Linear Copolymer with 2-Pyrrolidone as Final Solvent

In a preparation similar to 2b, the polymer 3a solution was prepared with 2-pyrrolidone as the final solvent. The resulting solids content was 43.93%, THF was 8.8% and 2-pyrrolidone was 47.27%.

ISD Dispersant 4 BZMA//MAA 5//1 Short B block

A 3-liter flask was equipped with a mechanical stirrer, thermometer, N₂ inlet, drying tube outlet, and addition funnels. Tetrahydrofuran THF, 1000.6 gm, was charged to the flask. The catalyst tetrabutyl ammonium m-chlorobenzoate, 4.0 ml of a 1.0 M solution in acetonitrile, was then added. Initiator, 1,1-bis (trimethylsiloxy)-2-methyl propene, 232.7 gm (1.00 moles) was injected. Feed I [benzyl methacrylate, 881.0 gm (5.00 moles)] was started at 0.0 minutes and added over 60 minutes.

At 190 minutes, 64.2 gm of methanol was added to the above solution and distillation began. During the first stage of distillation, 457.7 gm of material was removed. The final polymer was at 54.0% solids.

The polymer had a composition of BZMA//MAA 5//1. It had a molecular weight of Mn=886 and a acid value of 0.90 (milliequivalents/gram of polymer solids.) based on total solids.

### ISD Dispersant 4b BZMA//MAA 5//1 Short B Block

The same preparation was used as in preparation 4b except the monomers BZMA//MAA were used in a mole ratio of 5//1. This made a polymer of 43.75% solids in 2-pyrolidone

### ISD Dispersant 5 BZMA//MAA//BZMA 8//10//8 Triblock Copolymer

A 5-liter flask was equipped with a mechanical stirrer, thermometer, N₂ inlet, drying tube outlet, and addition funnels. THF, 1721.0 g, was charged to the flask. The catalyst (tetrabutyl ammonium m-chlorobenzoate, 1.9 ml of a 1.0 M solution in acetonitrile) was then added. Initiator (1-methoxy-1-trimethylsiloxy-2-methyl propene, 80.17 g (0.46 moles)) was injected. Feed I (tetrabutyl ammonium m-chlorobenzoate, 1.8 ml of a 1.0 M solution in acetonitrile and THF, 16.92 g) was started and added over 210 minutes. Feed II (BZMA, 649.3 g (3.69 moles)) was started at 0.0 minutes and added over 45 minutes. Thirty minutes after Feed II was completed (over 99% of the monomers had reacted), Feed III (trimethylsilyl methacrylate, 726.7 g (4.60 moles)) was started and added over 30 minutes. One hundred and fifty minutes after Feed III was completed (over 99% of the monomers had reacted), Feed IV (BZMA, 647.5 g (3.68 moles)) was started and added over 30 minutes.

At 500 minutes, 300.0 g of methanol was added to the above solution and distillation began. 750.0 g of material was removed to produce a final polymer solution of 51.5% solids in tetrahydrofuran.

The polymer has a composition of BZMA//MAA//BZMA 8//10//8, a molecular weight (Mn) of 3780, and an acid value of 2.88 (meq/gram of polymer solids) based on total solids.

### ISD Dispersant 6 BZMA/ETEGMA/MAA 84/10/6 Random Linear Copolymer

A 3-liter flask was equipped with a mechanical stirrer, thermometer, N₂ inlet, drying tube outlet, and addition funnels. THF, 1200 g, was charged to the flask. The catalyst (tetrabutyl ammonium m-chlorobenzoate, 0.76 ml of a 1.0 M solution in acetonitrile) was then added. Initiator (1-methoxy-1-trimethylsiloxy-2-methyl propene, 32 g (0.18 moles)) was injected. Feed I (tetrabutyl ammonium m-chlorobenzoate, 0.76 ml of a 1.0 M solution in acetonitrile and THF, 10 g) was started and added over 300 minutes. Feed II (trimethylsilyl methacrylate, 99.4 g (0.63 moles), benzyl methacrylate, 754.1 g (4.28 moles), and ethoxy triethylene glycol methacrylate (ETEGMA), 92.1 g (0.37 moles)) was started at 0.0 minutes and added over 45 minutes.

At 175 minutes, 55 g of methanol was added to the above solution and distillation begun. 350.5 g of material was removed to produce a final polymer solution of 49.1% solids.

The polymer had a composition of BZMA/ETEGMA/MAA 84/10/6, molecular weight (Mn) of 4994, and an acid value of 0.79 (meq/gram of polymer solids) based on total solids.

### ISD Dispersant 7 BZMA//DMAEMA 13//3.4 Diblock Copolymer

A 3-liter flask was equipped with a mechanical stirrer, thermometer, N₂ inlet, drying tube outlet, and addition funnels. THF, 540 g, was charged to the flask. The catalyst (tetrabutyl ammonium m-chlorobenzoate, 0.69 g of a 1.0 M solution in acetonitrile) was then added. Initiator (1-methoxy-1-trimethylsiloxy-2-methyl propene, 29.8 g (0.17 moles)) was injected. Feed I (tetrabutyl ammonium m-chlorobenzoate, 0.35 g of a 1.0 M solution in acetonitrile and THF, 5 g) was started and added over 150 minutes. Feed II (N,N-dimethylaminoethylmethacrylate, 92.3 g (0.59 moles)) was started at 0.0 minutes and added over 30 minutes. Feed III (benzyl methacrylate, 390.8 g (2.22 moles)) was started at 60 minutes and was added over 30 minutes.

At 135 minutes, 11 g of methanol was added to the above solution and Feed I was stopped. Distillation was used to remove 48 g of material, resulting in a final polymer solution of 47.3% solids.

The polymer had a composition of BZMA//DMAEMA 13//3.4 (mole ratio), a theoretical molecular weight (Mn) of 2930, and an amine value of 1.18 (meq/gram of polymer solids) based on total solids.

### ISD Dispersant 8a BZMA/DMAEMA 85.5/14.5 Random Linear Copolymer

A 3-liter flask was equipped with a mechanical stirrer, thermometer, N₂ inlet, drying tube outlet, and addition funnels. THF, 552 g, was charged to the flask. The catalyst (tetrabutyl ammonium m-chlorobenzoate, 0.37 g of a 1.0 M solution in acetonitrile) was then added. Initiator (1-methoxy-1-trimethylsiloxy-2-methyl propene, 16.8 g (0.096 moles)) was injected. Feed I (tetrabutyl ammonium m-chlorobenzoate, 0.19 g of a 1.0 M solution in acetonitrile and THF, 5 g) was started and added over 150 minutes. Feed II (N,N-dimethylaminoethylmethacrylate, 71.7 g (0.46 moles) and benzyl methacrylate, 419.6 g (2.38 moles)) was started at 0.0 minutes and added over 30 minutes.

At 85 minutes, 6.6 g of methanol was added to the above solution and Feed I was stopped. Distillation was used to remove 28.5 g of material, resulting in a final polymer solution of 47.8% solids.

The polymer had a composition of BZMA/DMAEMA 85.5/14.5 (weight ratio), a theoretical molecular weight (Mn) of 5370, and an amine value of 0.92 (meq/gram of polymer solids) based on total solids.

### ISD Dispersant 9 BZMA//MAA 13//3 Short B Block Copolymer

A 12-liter flask was equipped with a mechanical stirrer, thermometer, N₂ inlet, drying tube outlet, and addition funnels. THF, 3866 g, was charged to the flask. The catalyst (tetrabutyl ammonium m-chlorobenzoate, 1.2 ml of a 1.0M solution in acetonitrile) was then added. Initiator (1,1-bis(trimethylsilyloxy)-2-methyl propene, 281.1 g (1.21 moles)) was injected. Feed I (trimethylsilyl methacrylate, 382.8 g (2.42 moles)) was started and added over 30 minutes. At 117 minutes, Feed II (benzyl methacrylate, 2767.7 g (15.73 moles)) was started and added over 64 minutes. At 240 minutes, 232 g of methanol was added to the above solution, and distillation begun. 1180 g of material was removed, resulting in a final polymer solution of 50.82% solids.

The polymer had a composition of BZMA//MAA 13//3 (mole ratio), a molecular weight (Mn) of 2522, a polydispersity of 1.26, and an acid value of 1.23 (meq/gram of polymer solids) based on total solids

### (CP1) Comparative Dispersion Polymer 1 ETEGMA//BZMA//MAA 3.6//13.6//10.8

The following is an example of how to make a block polymer that has both ionic as well as steric stabilization.

A 3-liter flask was equipped with a mechanical stirrer, thermometer, N₂ inlet, drying tube outlet, and addition funnels. Tetrahydrofuran THF, 291.3 gm, was charged to the flask. The catalyst tetrabutyl ammonium m-chlorobenzoate, 0.44 ml of a 1.0 M solution in acetonitrile, was then added. Initiator, 1,1-bis (trimethylsiloxy)-2-methyl propene, 20.46 gm (0.0882 moles) was injected. Feed I [tetrabutyl ammonium m-chlorobenzoate, 0.33 ml of a 1.0 M solution in acetonitrile and THF, 16.92 gm] was started and added over 185 minutes. Feed II [trimethylsilyl methacrylate, 152.00 gm (0.962 moles)] was started at 0.0 minutes and added over 45 minutes. One hundred and eighty minutes after Feed II was completed (over 99% of the monomers had reacted) Feed III [benzyl methacrylate, 211.63 gm (1.20 moles) was started and added over 30 minutes. Forty minutes after Feed III was completed (over 99% of the monomers had reacted) Feed IV [ethoxytriethyleneglycol methacrylate, 78.9 gm (0.321 moles) was started and added over 30 minutes.

At 400 minutes, 73.0 gm of methanol and 111.0 gm of 2-pyrrolidone was added to the above solution and distillation began. During the first stage of distillation, 352.0 gm of material was removed. Then more 2-pyrrolidone 340.3 gm was added and an additional 81.0 gm of material was distilled out. Finally, 2-pyrrolidone, 86.9 gm total, was added. The final polymer was at 40.0% solids.

The polymer has a composition of ETEGMA//BZMA//MAA 3.6//13.6//10.8. It has a molecular weight of Mn=4,200, acid value 2.90.

Neutralization of Comparative Polymer 1 with Potassium Hydroxide

The following ingredients were combined with stirring:

| INGREDIENT | AMOUNT (GM) |
|---|---|
| Comparison Polymer preparation 1 | 50.0 |
| 45% aqueous potassium hydroxide solution | 6.2 |
| D.I. Water | 43.8 |

### (CP2) Comparative Dispersant Polymer 2-BZMA//MAA 13//10

The following is an example of how to make a block polymer that has both ionic as well as steric stabilization. The composition was BZMA//MAA 13//10.

A 12-liter flask was equipped with a mechanical stirrer, thermometer, N₂ inlet, drying tube outlet, and addition funnels. THF, 3750 g, and p-xylene, 7.4 g, were charged to the flask. The catalyst (tetrabutyl ammonium m-chlorobenzoate, 3.0 ml of a 1.0 M solution in acetonitrile) was then added. Initiator (1,1-bis (trimethylsiloxy)-2-methyl propene, 291.1 g (1.25 moles)) was injected. Feed I (tetrabutyl ammonium m-chlorobenzoate, 3.0 ml of a 1.0 M solution in acetonitrile) was started and added over 180 minutes. Feed II (trimethylsilyl methacrylate, 1975 g (12.5 moles)) was started at 0.0 minutes and added over 35 minutes. One hundred minutes after Feed II was completed (over 99% of the monomers had reacted), Feed III (benzyl methacrylate, 2860 g (16.3 moles)) was started and added over 30 minutes.

At 400 minutes, 720 g of methanol was added to the above solution and distillation begun. During the first stage of distillation, 1764.0 g of material was removed. Then more methanol 304.0 g was added and an additional 2255.0 g of material was distilled out. The final polymer solution was at 49.7% solids.

The polymer had a composition of BZMA//MAA 13//10, a molecular weight (Mn) of 3200, and an acid value of 3.52 (meq/gram of polymer solids) based on total solids.

### Polyurethane Ink Additives

### Polyurethane Ink Additive Example 1 IPDI/500 PO3G/DMPA AN30

The preparation was identical to Polyurethane Ink Additive Example 2 (prepared below) except that isophorone diisocyanate was used instead of toluene diisocyanate and the formulation was adjusted for molecular weight differences in order to maintain the same NCO/OH ratio. The polyurethane dispersion had a viscosity of 24.4% solids, 22.1 cPs, particle size of d50=nm and d95=nm, and molecular weight by GPC of Mn 8170, Mw 18084, and Pd 2.21. The urea content is 4.2%.

### Polyurethane Ink Additive Example 2 TDI/500 PO3G/DMPA AN30

A 2 L reactor was loaded with 166.4 PO3G (545 MW, 95.8 g tetraethylene glycol dimethyl ether, and 21.2 g dimethylol proprionic acid. The mixture was heated to 110° C. under vacuum until contents had less than 400 ppm water; approximately 3.5 hrs. Then the reaction was cooled to 70° C., and over 30 minutes, 89.7 g Toluene diisocyanate was added followed by 15.8 g tetraethylene glycol dimethyl ether. The reaction was held at 80° C. for 2 hrs when the % NCO was below 1.5%. Then, 12.4 g bis(2-methoxy ethyl) amine was added over 5 minutes. After 1 hr at 60° C., removed 50 g for analysis. The remaining polyurethane solution was inverted under high speed mixing by adding a mixture of 45% KOH (15.5 g) and 218.0 g water followed by an additional 464 g water. The polyurethane dispersion had a viscosity of 17.6 cPs, 22.9% solids, particle size of d50=16 nm and d95=35 nm, and molecular weight by GPC of Mn 7465, Mw 15500, and Pd 2.08. Urea content, 4.3

### Polyurethane Ink Additive Example 3 IPDI/T250/DMPA BMEA AN30

A 2 L reactor was loaded with 104.3 Terathane 250, 95.2 g tetraethylene glycol dimethyl ether, and 20.8 g dimethylol proprionic acid. The mixture was heated to 115° C. with N2 purge for 1 hr. Then the reaction was cooled to 70° C., and 0.4 g dibutyl tin dilaurate was added. Over 30 minute's 142.7 g isophorone diisocyanate was added followed by 23.8 g tetraethylene glycol dimethyl ether. The reaction was held at 80° C. for 4.5 hrs when the % NCO was below 1.0%. Then, 15.6 g bis(2-methoxy ethyl) amine was added over 5 minutes. After 1 hr at 80° C., the polyurethane solution was inverted under high speed mixing by adding a mixture of 45% KOH (15.2 g) and 214 g water followed by an additional 443 g water. The polyurethane dispersion had a pH of 8.2, 25.4% solids, viscosity of 17.8 cPs, and particle size of d50=16 nm and d95=24 nm.

### Polyurethane Ink Additive Example 4 IPDI/T650/DMPA AN30

A 2 L reactor was loaded with 154.3 g Terathane® 650, 95.2 g tetraethylene glycol dimethyl ether, and 20.4 g dimethylol proprionic acid. The mixture was heated to 110° C. with N2 purge for 10 min. Then the reaction was cooled to 80° C., and 0.4 g dibutyl tin dilaurate was added. Over 30 minute's 96.0 g isophorone diisocyanate was added followed by 24.0 g tetraethylene glycol dimethyl ether. The reaction was held at 80° C. for 2 hrs when the % NCO was below 1.2%. Then, 10.6 g bis(2-methoxy ethyl) amine was added over 5 minutes. After 2 hr at 80° C., the polyurethane solution was inverted under high speed mixing by adding a mixture of 45% KOH (16.8 g) and 236 g water followed by additional 467 g water. The polyurethane dispersion had a viscosity of 11.4 cPs, 25.3% solids, particle size of d50=22 nm and d95=35 nm, and molecular weight by GPC of Mn 6520, Mw 16000, and Pd 2.5. The urea content is 8.8%.

### Polyurethane Ink Additive Example 5 TDI/T650/DMPA AN30

A 2 L reactor was loaded with 164.6 Terathane 650, 101.4 g tetraethylene glycol dimethyl ether, and 21.6 g dimethylol proprionic acid. The mixture was heated to 115° C. with N₂ purge for 1 hr. Then the reaction was cooled to 70° C., and over 30 minutes 81.1 g toluene diisocyanate was added followed by 20.6 g tetraethylene glycol dimethyl ether. The reaction was held at 80° C. for 5 hrs when the % NCO was below 1.5%. Then, 11.2 g bis(2-methoxy ethyl) amine was added over 5 minutes. After 2 hr at 80° C., the polyurethane solution was inverted under high speed mixing by adding a mixture of 45% KOH (15.8 g) and 221.9 g water followed by additional 418 g water. The polyurethane dispersion had pH of 7.9, 22.7% solids, viscosity of 27.1 cPs, particle size of d50=15 nm and d95=25 nm, and molecular weight by GPC of Mn 8557, Mw 16951, and Pd 1.98.

### Polyurethane Ink Additive Example 6 IPDI/T650/DMPA AN30

A 2 L reactor was loaded with 154.3 Terathane 650, 95.2 g tetraethylene glycol dimethyl ether, and 20.3 g dimethylol proprionic acid. The mixture was heated to 115° C. with N2 purge for 1 hr. Then the reaction was cooled to 70° C., and 0.4 g dibutyl tin dilaurate was added. Over 30 minute's 96.0 g isophorone diisocyanate was added followed by 23.8 g tetraethylene glycol dimethyl ether. The reaction was held at 80° C. for 4.5 hrs when the % NCO was below 1.3%. Then, 10.5 g bis(2-methoxy ethyl) amine was added over 5 minutes. After 1 hr at 80° C., the polyurethane solution was inverted under high speed mixing by adding a mixture of 45% KOH (14.9 g) and 208.5 g water followed by an additional 440 g water. The polyurethane dispersion had a pH of 7.9, 24.4% solids, particle size of d50=19 nm and d95=30 nm, and molecular weight by GPC of Mn 9057, Mw 18641, and Pd 2.06. Urea content, 3.7

### Polyurethane Ink Additive Example 7 IPDI/T650/DMPA AN45

A 2 L reactor was loaded with 136.7 g Terathane® 650, 84.3 g tetraethylene glycol dimethyl ether, and 32.1 g dimethylol proprionic acid. The mixture was heated to 110° C. with N2 purge for 1 hr. Then the reaction was cooled to 80° C., and 0.3 g dibutyl tin dilaurate was added. Over 30 minute's 108.9 g isophorone diisocyanate was added followed by 28.2 g tetraethylene glycol dimethyl ether. The reaction was held at 80° C. for 5.5 hrs when the % NCO was below 1.6%. Then, 11.9 g bis(2-methoxy ethyl) amine was added over 5 minutes. After 2 hr at 80° C., the polyurethane solution was inverted under high speed mixing by adding a mixture of 45% KOH (22.8 g) and 320 g water followed by an additional 361.5 g water. The polyurethane dispersion had a viscosity of 20.6 cPs, 23.7% solids, particle size of d50=14 nm and d95=18 nm, and molecular weight by GPC of Mn 6320, Mw 17000, and Pd 2.7. The urea content is 4.1%.

### Polyurethane Ink Additive Example 8 IPDI/T650/DMPA AN60

The preparation was identical to Polyurethane Ink Additive Example 1 except with additional dimethylol proprionic acid replacing some of the Terathane 650 to adjust the final acid number of the polyurethane to 60 mg KOH/g polymer while maintaining the same NCO/OH ratio. This polyurethane dispersion had a viscosity of 21 cPs at 24.1% solids, particle size of d50=19 nm and d95=24 nm, and molecular weight by GPC of Mn 5944. Urea content, 4.5%

### Polyurethane Ink Additive Example 9a DEA Terminated 1, 6 Hexane Diol, AN60

To a dry, alkali- and acid-free flask, equipped with an addition funnel, a condenser, stirrer and a nitrogen gas line was added 55 g 1, 6 Hexanediol, 48 g DMPA, 32.2 g TEA, 100 g acetone and 0.06 g DBTL. The contents were heated to 40° C. and mixed well. 227 g IPDI was then added to the flask via the addition funnel at 40° C. over 60 min, with any residual IPDI being rinsed from the addition funnel into the flask with 10 g acetone.

The flask temperature was raised to 50° C., held at 50° C. until NCO % was 3.5%% or less, then 39.5 gram DEA was added over 5 minutes followed by 5 gram acetone rinse. After 1 hour at 50° C., 613 g deionized (DI) water was added over 10 minutes via the addition funnel. The mixture was held at 50° C. for 1 hr, then cooled to room temperature. Acetone (−115 g) was removed under vacuum, leaving a polyurethane solution with about 35.0% solids by weight. The final polyurethane dispersion had a viscosity of 30 cPs, pH 7.5, particle size of d50=86.5 nm

### Polyurethane Ink Additive Example 9b IPDI/HD BMEA AN30

A 2 L reactor was loaded with 70.9 1,6-hexane diol, 55.3 g tetraethylene glycol dimethyl ether, and 21.5 g dimethylol proprionic acid. The mixture was heated to 110° C. with N2 purge for 30 min. Then the reaction was cooled to 80° C., and 0.5 g dibutyl tin dilaurate was added. Over 30 minute's 185.8 g isophorone diisocyanate was added followed by 45.8 g tetraethylene glycol dimethyl ether. The reaction was held at 85° C. for 2 hrs when the % NCO was below 2.1%. Then, 20.3 g bis(2-methoxy ethyl) amine was added over 5 minutes. After 1 hr at 85° C., the polyurethane solution was inverted under high speed mixing by adding a mixture of 45% KOH (15.7 g) and 222 g water followed by additional 489 g water. The polyurethane dispersion had a viscosity of 9.9 cPs, 25.3% solids, pH 8.0, particle size of d50=17 nm and d95=26 nm, and molecular weight by GPC of Mn 5611, Mw 10316, and PD 1.8. Urea content, 6.8%.

### Polyurethane Ink Additive Example 10 IPDI/DDD BMEA AN30

A 2 L reactor was loaded with 95.9 1,12-dodecane diol, 74.9 g tetraethylene glycol dimethyl ether, and 20.6 g dimethylol proprionic acid. The mixture was heated to 110° C. with N2 purge for 1 hr. Then the reaction was cooled to 80° C., and 0.4 g dibutyl tin dilaurate was added. Over 30 minute's 153.5 g isophorone diisocyanate was added followed by 37.9 g tetraethylene glycol dimethyl ether. The reaction was held at 85° C. for 2 hrs when the % NCO was below 1.8%. Then, 16.9 g bis(2-methoxy ethyl) amine was added over 5 minutes. After 1 hr at 85° C., the polyurethane solution was inverted under high speed mixing by adding a mixture of 45% KOH (16.9 g) and 214 g water followed by an additional 458 g water. The polyurethane dispersion had a viscosity of 11.2 cPs, 25.4% solids, pH 7.9, particle size of d50=17 nm and d95=25 nm, and molecular weight by GPC of Mn 6640, Mw 12615, and PD 1.9. Urea content, 5.9%

### Polyurethane Ink Additive Example 11 IPDI/1000 PEG/DMPA BMEA AN20

A 2 L reactor was loaded with 154.1 g Polyethylene Glycol (1075 MW, Carbowax Sentry from Dow), 88.1 g tetraethylene glycol dimethyl ether, and 18.0 g dimethylol proprionic acid. The mixture was heated to 110° C. under vacuum. Then the reaction was cooled to 75° C., and 0.2 g dibutyl tin dilaurate was added. Over 30 minute's 71.1 g isophorone diisocyanate was added followed by 11.7 g tetraethylene glycol dimethyl ether. The reaction was held at 80° C. for 5.5 hrs when the % NCO was below 1.0%. Then, 7.8 g bis(2-methoxy ethyl) amine was added over 5 minutes. After 1 hr at 80° C., the polyurethane solution was inverted under high speed mixing by adding a mixture of 45% KOH (15.1 g) and 211.0 g water followed by additional 420 g water. The polyurethane dispersion had a viscosity of 59.2 cPs, pH of 6.7, 23.9% solids, and particle size of d50=4 nm and d95=7 nm. Urea content, 3/1%

### Polyurethane Ink Additive Example 12 11IPDI/HQEE/DMPA BMEA AN30

A 2 L reactor was loaded with 95.2 hydroquinone di-(beta-hydroxyethyl)ether (Poly-G HQEE from Arch Chemical), 74.3 g tetraethylene glycol dimethyl ether, and 20.8 g dimethylol proprionic acid. The mixture was heated to 115° C. with N2 purge for 1 hr. Then the reaction was cooled to 85° C., and over 30 minutes 154.5 g isophorone diisocyanate was added followed by 38.1 g tetraethylene glycol dimethyl ether. After isocyanate feed was complete, 0.3 g dibutyl tin dilaurate was added. The reaction was held at 85° C. for 4 hrs when the % NCO was below 1.9%. Then, 16.9 g bis(2-methoxy ethyl) amine was added over 5 minutes. After 1 hr at 80° C., the polyurethane solution was inverted under high speed mixing by adding a mixture of 45% KOH (15.4 g) and 214 g water followed by an additional 458 g water. The polyurethane dispersion had a viscosity of 34.4 cPs, 25.3% solids, pH of 8.46, particle size of d50=11 nm and d95=16 nm, and molecular weight by GPC of Mn 6445, Mw 12473, and Pd 1.94. Urea content, 5.9%

### Polyurethane Ink Additive Example 13 IPDI/500PC/DMPA BMEA AN30

A 2 L reactor was loaded with 146.3 Eternacoll UH50 (Ube polycarbonate diol, 501 MW), 84.2 g tetraethylene glycol dimethyl ether, and 20.8 g dimethylol proprionic acid. The mixture was heated to 75° C. with N2 purge for 1 hr. Then 0.5 g dibutyl tin dilaurate was added, and over 30 minutes 109.4 g isophorone diisocyanate was added followed by 28.1 g tetraethylene glycol dimethyl ether. The reaction was held at 80° C. for 1.5 hrs when the % NCO was below 1.1%. Then, 12.0 g bis(2-methoxy ethyl) amine was added over 5 minutes. After 1 hr at 80° C., the polyurethane solution was inverted under high speed mixing by adding a mixture of 45% KOH (15.3 g) and 225 g water followed by additional 450.2 g water. The polyurethane dispersion had a viscosity of 8.8 cPs, 24.4% solids, pH of 8.1, and particle size of d50=14 nm and d95=28 nm. Urea content 4.16%.

### Polyurethane Ink Additive Example 14 (Crosslinked Polyurethane)

To a dry, alkali- and acid-free flask, equipped with an addition funnel, a condenser, stirrer and a nitrogen gas line, was added 699.2 g Desmophene C 200, 280.0 g acetone and 0.06 g DBTL. The contents were heated to 40° C. and mixed well. 189.14 g IPDI was then added to the flask via the addition funnel at 40° C. over 60 min, with any residual IPDI being rinsed from the addition funnel into the flask with 15.5 g acetone.

The flask temperature was raised to 50° C., then held for 30 minutes. 44.57 g DMPA followed by 25.2 g TEA was added to the flask via the addition funnel, which was then rinsed with 15.5 g acetone. The flask temperature was then raised again to 50° C. and held at 50° C. until NCO % was less than 1.23%.

With the temperature at 50° C., 1498.0 g deionized (DI) water was added over 10 minutes, followed by mixture of 24.4 g EDA (as a 6.25% solution in water) and 118.7 g TETA (as a 6.25% solution in water) over 5 minutes, via the addition funnel, which was then rinsed with 80.0 g water. The mixture was held at 50° C. for 1 hr, then cooled to room temperature.

Acetone (−310.0 g) was removed under vacuum, leaving a final dispersoid of polyurethane with about 35.0% solids by weight.

For polyurethane dispersoid 2 the crosslinking was achieved by the Tetraethylenetriamine. Urea content is 0.95 wt %

### Polyurethane Ink Additive Example 15 12IPDI/15DHE T650 BMEA 45AN 90% KOH

A 2 L reactor was loaded with 109.7 g Terathane® 650, 33.8 g tetraethylene glycol dimethyl ether, and 6.6 g Dantocol DHE (1,3-dihydroxyethyl dimethyl hydantoin) and 27.0 g dimethylol proprionic acid. The mixture was heated to 75° C. with N₂ purge for 20 minutes. Then, 0.4 g dibutyl tin dilaurate was added. Over 60 minute's 96.6 g isophorone diisocyanate was added followed by 8.0 g tetraethylene glycol dimethyl ether. The reaction was held at 80° C. for 4 hrs when the corrected % NCO was below 1.5%. Then, 9.7 g bis(2-methoxy ethyl) amine was added over 5 minutes. After 1 hr at 80° C., the polyurethane solution was inverted under high speed mixing by adding a mixture of 45% KOH (22.6 g) and 317 g water followed by additional 372 g water. The polyurethane dispersion had a viscosity of xxx cPs, xxx % solids, particle size of d50=xx nm and d95=xx nm, and molecular weight by GPC of Mn xxx, Mw xxx, and Pd xx. The urea content is 3.9%.

### Dispersion Preparation 1—Black Dispersion (PD1)

An aqueous black pigment dispersion was prepared by mixing the following ingredients with adequate stirring:

The dispersion was prepared with the following recipe:

| INGREDIENT | AMOUNT (G) |
|---|---|
| Polymer (from 2b) | 80.14 |
| Lithium Hydroxide (98% solid) | 1.43 |
| Deionized water | 140 |
| Carbon Black (FW-18 Degussa) | 75 |
| Proxel ® GXL | 3.7 |
| Dowanol ® DPM | 319.73 |

The listed ingredients were well mixed and then dispersed using a Microfluidics system. Above was then diluted with 138 g of water and dispersed again with a Microfluidics system to yield a 10 wt % pigment solids dispersion with an average particle size of 119 nm.

### Dispersion Preparation 2—Magenta Dispersion (PD2)

An aqueous magenta pigment dispersion was prepared by first milling the following ingredients on a 2 roll mill.

| INGREDIENT | AMOUNT (G) |
|---|---|
| Polymer (from 2a) | 275.59 |
| Magenta pigment (Monastral RT-355-D CIBA) | 210.0 |
| Tetraethylene glycol | 52.5 |

This was milled and made a magenta dispersion in a chip form that was 89.7 wt % solids. This was then let down by first mixing the following ingredients:

| INGREDIENT | AMOUNT (G) |
|---|---|
| Magenta chip | 167.24 |
| Lithium hydroxide | 2.29 |
| Deionized water | 300.61 |
| Proxel ® GXL | 1.50 |
| Dowanol ® DPM | 128.28 |

Then, the dispersion was mixed in a high speed disperser for 4 hours at 3000 rpm. After that 500.0 g of the dispersion was removed and mixed with 53.75 g of Dowanol® DPM and 253.75 g of deionized water. This dispersion was then milled in a media mill. The dispersion was then purified by diluting with water and removing excess solvents through an ultrafiltration process to generate a 14.09 wt % pigment solids dispersion that has less than 1.0 wt % of solvent (other than water).

### Dispersion Preparation 3—Cyan Dispersion (PD3)

An aqueous cyan pigment dispersion was prepared by first milling the following ingredients on a 2 roll mill.

| INGREDIENT | AMOUNT (G) |
|---|---|
| Polymer (from 2a) | 420.96 |
| Cyan pigment (Aztech Chemisperse CC1531) | 433.33 |
| Tetraethylene glycol | 52.50 |

This was milled and made a cyan dispersion in a chip form that was 93.45 wt % solids. This was then let down by first mixing the following ingredients

| INGREDIENT | AMOUNT (G) |
|---|---|
| Cyan chip | 147.16 |
| 10% Lithium hydroxide monohydrate | 16.84 |
| Deionized water | 314.51 |
| Proxel ® GXL | 1.50 |
| Dowanol ® DPM | 120.00 |

Then, the dispersion was mixed in a high speed disperser for 3 hours at 4000 rpm and then followed by 4 hours milling in a media mill. The dispersion was then purified by diluting 341 g of material with 441 g deionized water, and removing excess solvents through an ultrafiltration process to generate a 13.65 wt % pigment solids dispersion that had less than 1.0 wt % of solvent (other than water), and average particle size of 123 nm.

### Dispersion Preparation 4—Yellow Dispersion (PD4)

An aqueous yellow pigment dispersion was prepared by first milling the following ingredients on a 2 roll mill.

| INGREDIENT | AMOUNT (G) |
|---|---|
| Polymer (from 2a) | 226.67 |
| Yellow pigment (Aztech Chemisperse CY7480) | 233.33 |
| Tetraethylene glycol | 49.0 |

This was milled and made a yellow dispersion in a chip form that was 89.16 wt % solids. This was then let down by first mixing the following ingredients:

| INGREDIENT | AMOUNT (G) |
|---|---|
| Yellow chip | 151.58 |
| 10% Lithium hydroxide monohydrate | 16.84 |
| Deionized water | 370.08 |
| Proxel ® GXL | 1.50 |
| Triethyleneglycol monobutyl ether | 60.00 |

Then, the dispersion was mixed in a high speed disperser (HSD) for 4 hours at 3000 rpm. It was then milled 4 hours in a media mill. The dispersion was then purified by diluting 281 g of material with 141 g deionized water and removing excess solvents through an ultrafiltration process to yield a 18.37 wt % pigment solids dispersion that has less than 1.0 wt % of solvent (other than water), and an average particle size of 79 nm.

### Comparison Dispersion Preparation 3—Self-Dispersed Black Pigment (CDP3)

Prepared by methods described in previously incorporated U.S. Pat. No. 6,852,156 Example 3.

### Tests of Polymeric Dispersions

For the ISD's, the ratio of hydrophilic and hydrophobic compositions is shown in the tables. For each of the entries the polymeric dispersants and polyurethane ink additives were prepared by the examples given above or similar synthetic methods. Likewise, the dispersions and inks were prepared by the procedures described above. For the random polymers, weight ratios are used; for the block polymers mole ratios of the monomer components were used.

Table 1 shows salt stability testing for ISD polymeric dispersants with carbon black pigments. For each of these polymeric dispersants the stable dispersion was prepared in a manner similar to Dispersion Preparation 1. The pigment was carbon black. Results for an SDP dispersant and an ink with a conventional dispersant are also shown.

Selected polyurethane ink additives may have the properties of an ISD dispersant. The dispersions were prepared in a manner similar to that described for the 92/8 dispersant system.

TABLE 1
Ionically Stabilized Dispersions: Salt test
Salt Molarity, NaCl

| Polymeric | Synthetic | | | | | | | | | | | |
|---|---|---|---|---|---|---|---|---|---|---|---|---|
| Dispersant | example | 0 | 0.02 | 0.04 | 0.06 | 0.08 | 0.10 | 0.12 | 0.14 | 0.16 | 0.18 | 0.2 |
| 90/10 | 1c | 0 | 0 | 0 | 0 | 0 | 1 | 1 | 1 | 2 | 2 | 3 |
| 92/8 | 2b | 0 | 1 | 1 | 1 | 1 | 2 | 2 | 2 | 2 | 3 | 3 |
| 94/6 | 3b | 0 | 0 | 0 | 2 | 2 | 3 | 3 | 3 | 3 | 3 | 3 |
| 1//5 | 4 | 0 | 0 | 1 | 2 | 2 | 3 | 3 | 3 | 3 | 3 | ND |
| 8//10//8 | 5 | 0 | 0 | 1 | 2 | 2 | 2 | 2 | 3 | 3 | 3 | 3 |
| SDP | see note 1 | 0 | 0 | 0 | 0 | 2 | 3 | 3 | 3 | 3 | 3 | 3 |
| PUD ink | Cyan | 0 | 0 | 0 | 1 | 2 | 3 | 3 | 3 | 3 | | |
| additive # 4 | Pigment | | | | | | | | | | | |
| PUD ink | Yellow | 0 | 0 | 0 | 0 | 2 | 3 | 3 | 3 | 3 | | |
| additive # 4 | Pigment | | | | | | | | | | | |
| Conventional | see note 2 | 0 | 0 | 0 | 0 | 0 | 1 | ND | ND | ND | ND | 1 |
| Dispersant | | | | | | | | | | | | |

Note 1
SDP Self Dispersed Pigment, prepared in manner similar to Example 1, WO0194476A2
Note 2
Conventional ETEGMA//BZMA//MAA Dispersant prepared according to Comparison Dispersant Dispersion Polymer 1
ND: Not Determined

The results in Table 1 shows that the 7 ISD polymers, when formulated with black pigment, meet the salt test criteria for the invention. Comparing the 90/10, 92/8 and 94/6 ISD's, the hydrophilic component decreases in this set and the salt stability test indicates that the polymeric dispersant will precipitate at lower salt concentrations. The two polyurethane tested as dispersants also satisfy the salt stability test as an ISD. The SDP material also meets the salt test criteria, but does not have a polymeric dispersant present. The conventional dispersant is a typical commercial formulation for Pigments for ink. Note that the conventional dispersant does not meet the invention criteria for the salt stability test. That is, at high salt concentrations the dispersion does not precipitate after 24 hours.

### Printing of Test ink Samples

The printing of the test examples was done in the following manner unless otherwise indicated. The printing for the ISD inks was done on a piezo Epson 980 printer (Epson America Inc, Long Beach, Calif.) using the black printhead which has a nominal resolution of 720 dots per inch for plain paper and 1440 dpi for the glossy paper. The printing was done in the software-selected standard print mode. Printing tests were also done with a thermal ink jet printer, an HP6122. The optical density and chroma were measured using a Greytag-Macbeth SpectoEye instrument (Greytag-Macbeth AG, Regensdorf, Switzerland). Plain paper OD values are the average of readings from prints made on three different plain papers: Hammermill Copy Plus paper, Hewlett-Packard Office paper and Xerox 4024 paper. The glossy paper results are from prints made using Epson Glossy Photo Paper, SO41286. Also printed was SO41062 is Epson Photo Quality Inkjet Paper (Matte Paper). Gloss was measured using a BYK-Gardner Micro-Tri-Gloss gloss meter (Gardner Co., Pompano Beach, Fla.). Inks prepared using the ISD's were printed and the optical properties measured. Black and other pigmented Inks were prepared by using the vehicles and ISD's listed in Table 2. Optical Density was tested on 3 different types of plain paper. All polymer formulations were based on the 2-pyrrolidone formulation that is 1c, 2b, 3b and 5 respectively.

TABLE 2
Comparative ISD Formulations with Black Pigment

| Black Pigment: | | Optical Density | | | |
|---|---|---|---|---|---|
| Degussa Nipex 160 | | Hammer | | | |
| Polymer used in Dispersion | Pigment | mill | Xerox | | |
| and ink preparation | Concentration | Copy Plus | 4024 | HP Office | Average |
| 90/10 BZMA/MAA; Vehicle 1 | 6% | 1.14 | 1.14 | 1.21 | 1.16 |
| 90/10 BZMA/MAA; Vehicle 2 | 3% | 1.11 | 1.06 | 1.15 | 1.11 |
| 92/8 BZMA/MAA; Vehicle 2 | 6% | 1.30 | 1.34 | 1.25 | 1.30 |
| 92/8 BZMA/MAA; Vehicle 2 | 3% | 1.48 | 1.46 | 1.36 | 1.43 |
| 94/6 BZMA/MAA; Vehicle 2 | 3% | 1.37 | 1.36 | 1.29 | 1.34 |
| 8//10//8 BZMA//MAA//BZMA; | 6% | 1.08 | 1.10 | 1.11 | 1.10 |
| Vehicle 1 | | | | | |
| ETEGMA//BZMA//MAA | 6% | 1.02 | 1.14 | 1.12 | 1.09 |
| (Comparison) Vehicle 2 | | | | | |
| ETEGMA//BZMA//MAA | 3% | 0.91 | 0.88 | 0.98 | 0.92 |
| (Comparison) Vehicle 2 | | | | | |
| SDP (Comparison) Vehicle 2 | 6% | 1.30 | 1.26 | 1.27 | 1.28 |
| SDP (Comparison) Vehicle 2 | 3% | 1.33 | 1.31 | 1.31 | 1.32 |

| Vehicle Formulation | # 1 | # 2 |
|---|---|---|
| 1,2-hexanediol | 4% | 4% |
| Glycerol | 15% | 10% |
| Ethylene glycol | 1% | 5% |
| Triethanolamine | 0.20% | 0% |
| Surfynol ® 465 | 0.90% | 0.20% |
| 2-pyrrolidone | 3% | 3% |

ETEGMA//BZMA//MAA Dispersant was prepared according to Comparison Dispersant Polymer 1.
SDP: Self Dispersed Pigment, prepared in manner similar to Example 1, of U.S. Pat. No. 6,852,156.

The ISD formulated inks without the polyurethane ink additive have better optical density than comparison inks with conventional dispersants. For the series of ISDs 90/10, 92/8, and 94/6, the optical density improves as the hydrophilicity decreases. For both the 92/8 and 94/6 ISDs, the optical density is better at both 3 and 6% loading

### Preparation of Inks with ISD Dispersants and Polyurethane Ink Additives

The inventive inks were made by adding the following components to the pigment dispersion in a manner similar to Comparative Ink Examples noted above except Polyurethane Ink Additives were added. The dispersant used was the 92/8 dispersant described in as ISD Dispersant 2b. All amounts shown in weight percent.

| | |
|---|---|
| Pigment | 3 to 6% |
| Polyurethane additive | 1 to 3% |
| 1,2-hexanediol | 4% |
| Glycerol | 10% |
| Surfynol 465 | 0.65% |
| 2-pyrrolidinone | 3% |
| Proxel | 0.25% |
| Water (Balance to 100%) | Bal. |

The source of the magenta pigments was EO2 from Clariant, Charlotte, N.C. and the black pigment was Nipex 180IQ supplied by DeGussa Parsippany, N.J.

Each of the ink shown in Tables 3-6 were printed and the optical properties measured. The 100% and 80% labeling on the gloss and DOI data are for 100% and 80% coverage respectfully.

### Magenta

TABLE 3
Optical Measurements from Inventive Inks, Magenta pigment, Optical
Density

| | | | | | Optical | | |
|---|---|---|---|---|---|---|---|
| | | | | Optical | Density | Optical | Optical |
| Ink | | % | % | Density | Xerox | Density | Density |
| example | Polyurethane | pigment | Binder | HCP | 4024 | SO41062 | SO41286 |
| 1 | PUD 1 | 3% | 1% | 0.89 | 0.99 | 1.19 | 1.95 |
| 2 | PUD 1 | 3% | 3% | 0.90 | 0.79 | N/a | N/a |
| 3 | PUD 1 | 6% | 1% | 1.00 | 1.06 | | 1.99 |
| 4 | PUD 2 | 3% | 1% | 0.86 | 0.96 | 1.19 | 1.86 |
| 5 | PUD 2 | 3% | 3% | 0.76 | 0.85 | 1.10 | 1.64 |
| 6 | PUD 2 | 6% | 1% | Did not print | | | |
| 7 | PUD 3 | 3% | 1% | 0.87 | 0.99 | 1.23 | 1.82 |
| 8 | PUD 3 | 3% | 3% | 0.79 | 0.85 | 1.19 | 1.59 |
| 9 | PUD 3 | 6% | 1% | 0.98 | 1.09 | | 2.08 |
| 10 | PUD 4 | 6% | 1% | 0.98 | 1.08 | | 2.05 |
| 11 | PUD 5 | 3% | 1% | 1 page printed | | | 1.94 |
| 12 | PUD 6 | 3% | 1% | 0.87 | 0.98 | 1.20 | 1.88 |
| 13 | PUD 6 | 3% | 3% | 0.78 | 0.84 | 1.16 | 1.56 |
| 14 | PUD 7 | 3% | 1% | 0.76 | 0.78 | | 1.75 |
| 15 | PUD 7 | 3% | 3% | 0.69 | 0.69 | | 1.70 |
| 16 | PUD 8 | 3% | 1% | 0.73 | 0.76 | | 1.61 |
| 17 | PUD 8 | 3% | 3% | 0.68 | 0.68 | | 1.52 |
| 18 | PUD 9b | 3% | 1% | 0.85 | 0.92 | 1.23 | 1.83 |
| 19 | PUD 9b | 3% | 3% | 0.81 | 0.89 | | 1.83 |
| 20 | PUD 10 | 3% | 1% | 0.83 | 0.91 | 1.24 | 1.85 |
| 21 | PUD 10 | 3% | 3% | 0.81 | 0.85 | 1.18 | 1.67 |
| 22 | PUD 11 | 3% | 1% | 0.87 | 0.97 | 1.24 | 1.79 |
| 23 | PUD 11 | 3% | 3% | 0.75 | 0.83 | 0.99 | 1.44 |
| 24 | PUD 12 | 3% | 1% | 1 page printed | | | 1.81 |
| 25 | PUD 13 | 3% | 1% | 1 page printed | | | 1.85 |
| Comp | NONE | 3% | 0% | 0.88 | 0.98 | 1.25 | 1.83 |
| Ink 4 | | | | | | | |
| Comp | NONE | 3% | 0% | 0.88 | 0.97 | 1.22 | 1.84 |
| Ink 5 | | | | | | | |
| Comp | NONE | 3% | 0% | 0.87 | 0.98 | 1.23 | 1.79 |
| Ink 6 | | | | | | | |
| Comp | NONE | 3% | 0% | 0.88 | 0.92 | | 1.83 |
| Ink 7 | | | | | | | |
| Comp | NONE | 6% | 0% | 1.04 | 1.08 | | 2.01 |
| Ink 8 | | | | | | | |

For some of the inventive inks shown above the data entries list that only 1 page was printed which indicates that the ink formulation was not stable or caused other problems with the printing. These formulations were not further optimized to minimize this effect. However the above data still indicate optical density is within the required range while gloss and DOI were not able to be measured. The comparative inks have comparable optical density results which is indicate that the polyurethane ink additive did not have an adverse effect on the optical density

TABLE 4
Optical Measurements from Inventive Inks, Magenta pigment,
Gloss, DOI

| | | | | Gloss | Gloss | | |
|---|---|---|---|---|---|---|---|
| Ink | | % | % | 60° | 60° | DOI | DOI |
| example | Polyurethane | pigment | Binder | 100% | 80% | 100% | 80% |
| 1 | PUD 1 | 3% | 1% | 92.10 | 74.20 | 1.849 | 1.525 |
| 2 | PUD 1 | 3% | 3% | N/a | N/a | N/a | N/a |
| 3 | PUD 1 | 6% | 1% | 62.90 | 55.80 | 0.992 | 1.210 |
| 4 | PUD 2 | 3% | 1% | 92.70 | 78.90 | 1.769 | 1.484 |
| 5 | PUD 2 | 3% | 3% | 78.80 | 61.70 | 1.403 | 1.179 |
| 6 | PUD 2 | 6% | 1% | Did not print | | | |
| 7 | PUD 3 | 3% | 1% | 73.00 | 71.40 | 1.627 | 1.355 |
| 8 | PUD 3 | 3% | 3% | 45.30 | 54.10 | Dull | 1.168 |
| 9 | PUD 3 | 6% | 1% | 59.30 | 55.20 | 1.059 | 1.105 |
| 10 | PUD 4 | 6% | 1% | 69.30 | 61.30 | 1.047 | 1.181 |
| 11 | PUD 5 | 3% | 1% | 95.90 | 79.90 | 1.886 | 1.501 |
| 12 | PUD 6 | 3% | 1% | 91.50 | 77.60 | 2.046 | 1.467 |
| 13 | PUD 6 | 3% | 3% | 39.20 | 55.80 | Dull | 1.223 |
| 14 | PUD 7 | 3% | 1% | 98.90 | 75.50 | 1.668 | 1.719 |
| 15 | PUD 7 | 3% | 3% | 76.70 | 66.10 | 1.319 | 1.299 |
| 16 | PUD 8 | 3% | 1% | 87.50 | 67.70 | 1.528 | 1.373 |
| 17 | PUD 8 | 3% | 3% | 54.10 | 53.70 | 1.106 | 1.236 |
| 18 | PUD 9b | 3% | 1% | 73.60 | 68.40 | 1.456 | 1.392 |
| 19 | PUD 9b | 3% | 3% | 62.50 | 66.50 | 1.078 | 1.260 |
| 20 | PUD 10 | 3% | 1% | 79.70 | 73.10 | 1.540 | 1.494 |
| 21 | PUD 10 | 3% | 3% | 44.30 | 58.30 | Dull | 1.156 |
| 22 | PUD 11 | 3% | 1% | 75.00 | 70.30 | 1.788 | 1.401 |
| 23 | PUD 11 | 3% | 3% | 74.90 | 59.30 | 1.206 | 1.243 |
| 24 | PUD 12 | 3% | 1% | 61.60 | 69.60 | 1.331 | 1.391 |
| 25 | PUD 13 | 3% | 1% | 84.80 | 76.40 | 1.921 | 1.436 |
| Comp | NONE | 3% | 0% | 60.20 | 71.80 | 1.353 | 1.370 |
| Ink 4 | | | | | | | |
| Comp | NONE | 3% | 0% | 63.30 | 69.00 | 1.384 | 1.357 |
| Ink 5 | | | | | | | |
| Comp | NONE | 3% | 0% | 58.40 | 62.40 | 1.266 | 1.350 |
| Ink 6 | | | | | | | |
| Comp | NONE | 3% | 0% | 59.00 | 69.40 | 1.393 | 1.418 |
| Ink 7 | | | | | | | |
| Comp | NONE | 6% | 0% | 48.00 | 55.40 | 0.981 | 1.201 |
| Ink 8 | | | | | | | |

For gloss and DOI the inventive inks at 1% loading of the polyurethane ink additives are significantly better than the comparative inks. For instance for PUD 2 had a gloss of 92.1 vs an average of about 61 for the comparative inks.

TABLE 5
Optical Measurements from Inventive Inks, Black pigment, Optical
Density

| | | | | | Optical | | |
|---|---|---|---|---|---|---|---|
| — | | | | Optical | Density | Optical | Optical |
| Ink | | % | % | Density | Xerox | Density | Density |
| Example | — | pigment | Binder | HCP | 4024 | SO41062 | SO41286 |
| 26 | PUD 1 | 3% | 1% | 0.93 | 1.02 | 1.39 | 1.86 |
| 27 | PUD 1 | 3% | 3% | 0.87 | 0.92 | 1.36 | 1.91 |
| 28 | PUD 1 | 6% | 1% | 1.05 | 1.12 | | 1.81 |
| 29 | PUD 1 | 6% | 3% | 1.01 | 1.08 | | 1.71 |
| 30 | PUD 1 | 6% | 5% | 0.95 | 0.99 | | 1.71 |
| 31 | PUD 2 | 3% | 1% | 0.89 | 0.96 | 1.41 | 2.00 |
| 32 | PUD 2 | 3% | 3% | 0.81 | 0.85 | 1.34 | 1.88 |
| 33 | PUD 2 | 6% | 1% | 1.03 | 1.12 | | 1.85 |
| 34 | PUD 3 | 3% | 1% | 0.89 | 0.99 | 1.43 | 2.06 |
| 35 | PUD 3 | 3% | 3% | 0.81 | 0.86 | n/a | 1.81 |
| 36 | PUD 3 | 6% | 1% | 1.03 | 1.12 | | 1.88 |
| 37 | PUD 4 | 6% | 1% | 1.01 | 1.12 | | 1.89 |
| 38 | PUD 5 | 3% | 1% | 0.86 | 0.92 | 1.41 | 2.05 |
| 39 | PUD 5 | 3% | 3% | 0.80 | 0.82 | 1.34 | 1.78 |
| 40 | PUD 6 | 3% | 1% | 0.88 | 0.98 | 1.41 | 2.05 |
| 41 | PUD 6 | 3% | 3% | 0.83 | 0.84 | 1.34 | 1.81 |
| 42 | PUD 7 | 3% | 1% | 0.85 | 0.87 | | 1.94 |
| 43 | PUD 7 | 3% | 3% | 0.79 | 0.77 | | 1.68 |
| 44 | PUD 8 | 3% | 1% | 0.84 | 0.85 | | 1.99 |
| 45 | PUD 8 | 3% | 3% | 0.79 | 0.75 | | 1.76 |
| 46 | PUD 9b | 3% | 1% | 0.92 | 0.97 | | 1.98 |
| 47 | PUD 9b | 3% | 3% | 0.87 | 0.89 | | 1.87 |
| 48 | PUD 10 | 3% | 1% | 0.87 | 0.89 | | 1.97 |
| 49 | PUD 10 | 3% | 3% | Could not | | | |
| | | | | print | | | |
| 50 | PUD 11 | 3% | 1% | 0.87 | 0.93 | 1.40 | 1.85 |
| 51 | PUD 11 | 3% | 3% | 0.85 | 0.89 | 1.36 | 1.75 |
| 52 | PUD 12 | 3% | 1% | 0.89 | 0.96 | 1.45 | 1.87 |
| 53 | PUD 12 | 3% | 3% | 0.85 | 0.88 | 1.38 | 1.97 |
| 54 | PUD 13 | 3% | 1% | 0.87 | 0.92 | 1.38 | 2.04 |
| 55 | PUD 13 | 3% | 3% | 0.80 | 0.83 | 1.34 | 1.81 |
| Comp Ink 9 | None | 3% | 0% | 0.95 | 0.98 | 1.43 | 1.75 |
| Comp Ink | None | 3% | 0% | 0.90 | 0.98 | 1.45 | 1.82 |
| 10 | | | | | | | |
| Comp Ink | None | 3% | 0% | 0.92 | 0.97 | 1.43 | 1.85 |
| 11 | | | | | | | |
| Comp Ink | None | 3% | 0% | 0.93 | 0.96 | | 1.86 |
| 12 | | | | | | | |
| Comp Ink | None | 6% | 0% | 1.05 | 1.14 | | 1.83 |
| 13 | | | | | | | |

Only one data entry lists that the ink could not be printed. This was at the 3% PUD ink additive level. This is over a wide range of pigment and polyurethane ink additive formulations. The comparative inks have comparable optical density results which is indicate that the polyurethane ink additive did not have an adverse effect on the optical density

TABLE 6
Optical Measurements from Inventive Inks, Black pigment, Gloss, DOI

| | | | | Gloss | Gloss | | | |
|---|---|---|---|---|---|---|---|---|
| — | | | | 60° | 60° | | DOI | DOI |
| Ink | | % | % | 100% | 80% | | 100% | 80% |
| Example | — | pigment | Binder | SO41286 | SO41286 | — | SO41286 | SO41286 |
| 26 | PUD 1 | 3% | 1% | 47.30 | 48.90 | | 1.097 | 1.309 |
| 27 | PUD 1 | 3% | 3% | 84.80 | 53.90 | | 2.293 | 1.270 |
| 28 | PUD 1 | 6% | 1% | 34.50 | 38.70 | | Dull | Dull |
| 29 | PUD 1 | 6% | 3% | 45.60 | 42.40 | | 0.899 | 1.459 |
| 30 | PUD 1 | 6% | 5% | 55.50 | 42.80 | | 1.151 | 1.434 |
| 31 | PUD 2 | 3% | 1% | 62.50 | 55.20 | | 1.320 | 1.457 |
| 32 | PUD 2 | 3% | 3% | 95.60 | 61.50 | | 2.055 | 1.544 |
| 33 | PUD 2 | 6% | 1% | 36.40 | 39.60 | | Dull | Dull |
| 34 | PUD 3 | 3% | 1% | 58.60 | 52.30 | | 1.217 | 1.244 |
| 35 | PUD 3 | 3% | 3% | 65.20 | 55.30 | | 1.310 | 1.329 |
| 36 | PUD 3 | 6% | 1% | 31.40 | 39.00 | | Dull | Dull |
| 37 | PUD 4 | 6% | 1% | 37.10 | 41.90 | | Dull | Dull |
| 38 | PUD 5 | 3% | 1% | 75.00 | 58.90 | | 1.369 | 1.394 |
| 39 | PUD 5 | 3% | 3% | 85.70 | 59.70 | | 1.613 | 1.536 |
| 40 | PUD 6 | 3% | 1% | 73.70 | 59.10 | | 1.376 | 1.429 |
| 41 | PUD 6 | 3% | 3% | 77.30 | 57.40 | | 1.615 | 1.462 |
| 42 | PUD 7 | 3% | 1% | 57.50 | 46.60 | | 1.369 | 1.398 |
| 43 | PUD 7 | 3% | 3% | 77.90 | 53.60 | | 2.127 | 1.488 |
| 44 | PUD 8 | 3% | 1% | 50.90 | 45.10 | | 1.186 | 1.547 |
| 45 | PUD 8 | 3% | 3% | 81.80 | 52.80 | | 2.112 | 1.585 |
| 46 | PUD 9b | 3% | 1% | 55.70 | 48.10 | | 1.18 | 1.407 |
| 47 | PUD 9b | 3% | 3% | 76.50 | 58.30 | | 1.39 | 1.378 |
| 48 | PUD 10 | 3% | 1% | 63.50 | 52.00 | | 1.29 | 1.595 |
| 49 | PUD 10 | 3% | 3% | | | | | |
| 50 | PUD 11 | 3% | 1% | 29.40 | 44.30 | | Dull | 1.284 |
| 51 | PUD 11 | 3% | 3% | 40.50 | 45.00 | | Dull | 1.332 |
| 52 | PUD 12 | 3% | 1% | 53.60 | 50.30 | | 1.154 | 1.304 |
| 53 | PUD 12 | 3% | 3% | 81.70 | 63.10 | | 1.327 | 1.309 |
| 54 | PUD 13 | 3% | 1% | 67.40 | 56.00 | | 1.265 | 1.354 |
| 55 | PUD 13 | 3% | 3% | 62.20 | 61.00 | | 1.160 | 1.482 |
| Comp Ink 9 | None | 3% | 0% | 20.8 | 42.5 | | Dull | 1.190 |
| Comp Ink | None | 3% | 0% | 24.60 | 45.40 | | Dull | 1.235 |
| 10 | | | | | | | | |
| Comp Ink | None | 3% | 0% | 29.90 | 48.00 | | Dull | 1.420 |
| 11 | | | | | | | | |
| Comp Ink | None | 3% | 0% | 24.90 | 39.10 | | Dull | Dull |
| 12 | | | | | | | | |
| Comp Ink | None | 6% | 0% | 22.70 | 36.40 | | Dull | Dull |
| 13 | | | | | | | | |

For the inks with both ISD dispersed pigments and Polyurethane Ink Additives the Gloss and DOI were improved relative to ISD preparations without the polyurethane additive.

To compare the inventive inks with ISD dispersants and polyurethane inks additive, black inks were prepared with ISD dispersants and polymeric additives that were identical to the ISD dispersants. The ISD dispersants in this case are also the same as the polyurethane ink additives. For each ink the pigment dispersion was prepared using conventional dispersion techniques. Then the ink was prepared by adding the other ingredients including the polymeric ink additive.

TABLE 7
ISD plus Polymeric Ink Additive

| | | | | | Optical | |
|---|---|---|---|---|---|---|
| | | % | | Optical | Density | Optical |
| | Dispersant | pigment: | Polymer | Density | Xerox | Density |
| # | — | Nipex 180 | ink additive | HCP | 4200 | SO41286 |
| Comp Ink | ISD 2a | 1.5% | ISD 2a | 0.76 | 0.78 | 1.74 |
| 14 | | | | | | |
| Comp Ink | ISD 2a | 3.0% | ISD 2a | 0.98 | 1.04 | 1.90 |
| 15 | | | | | | |
| Comp Ink | ISD 2a | 4.5% | ISD 2a | 1.12 | 1.17 | 1.88 |
| 16 | | | | | | |
| Comp Ink | ISD 2a | 6.0% | ISD 2a | 1.16 | 1.29 | 1.77 |
| 17 | | | | | | |
| Inv. Ink 56 | PUD # 4 | 1.5% | PUD ink add. # 4 | 0.75 | 0.82 | 1.85 |
| Inv. Ink 57 | PUD # 4 | 3.0% | PUD ink add. # 4 | 1.01 | 1.03 | 1.98 |
| Inv. Ink 58 | PUD # 4 | 4.5% | PUD ink add. # 4 | 1.10 | 1.14 | 1.93 |
| Inv. Ink 59 | PUD # 4 | 6.0% | PUD ink add. # 4 | 1.16 | 1.22 | 1.86 |
| | | | | Gloss | | |
| | | | Gloss 60° | 60° | DOI | DOI |
| | | | 100% | 80% | 100% | 80% |
| | | | SO41286 | SO41286 | SO41286 | SO41286 |
| Comp Ink | ISD 2a | 1.5% | 31.30 | 54.00 | DULL | 2.438 |
| 14 | | | | | | |
| Comp Ink | ISD 2a | 3.0% | 22.50 | 39.50 | DULL | DULL |
| 15 | | | | | | |
| Comp Ink | ISD 2a | 4.5% | 21.70 | 34.90 | DULL | DULL |
| 16 | | | | | | |
| Comp Ink | ISD 2a | 6.0% | 20.20 | 33.80 | DULL | DULL |
| 17 | | | | | | |
| Inv. Ink 56 | PUD # 4 | 1.5% | 66.70 | 72.50 | DULL | 2.660 |
| Inv. Ink 57 | PUD # 4 | 3.0% | 48.30 | 55.50 | DULL | 1.654 |
| Inv. Ink 58 | PUD # 4 | 4.5% | 38.40 | 47.20 | DULL | DULL |
| Inv. Ink 59 | PUD # 4 | 6.0% | 34.10 | 46.70 | DULL | DULL |

The inventive inks at 1.5, 3, 4.5 and 6 wt % polyurethane ink additive levels had significantly better Gloss at both 809 and 100% coverage. The DOI was better at the 1.5 and 3% levels. This may indicate that at 4.5 and 6% polymeric ink additive loadings the DOI is not measurable, or the ink had other printing problems that lead to the Dull result.

### Example of Crosslinked Polyurethane Ink Additive

Inventive inks were prepared and tested on paper and for printing on textiles. The textile printing was done according to procedures described in US20050215663. Magenta, cyan and yellow inks were prepared and tested. For the textile printing on cotton and polycotton the textiles were fused before measurement. 7409 @160° C. 2 min. and 419@190° C. 2 min.

TABLE 9
Crosslinked Polyurethane Ink Additive Example

| | | Xerox | | | |
|---|---|---|---|---|---|
| | | 4024 | Xerox 4024 | 419 | 7409 Poly |
| | | 720dpi | 1440dpi | Cotton | cotton |
| Inv. Ink 60 | Magenta | 0.96 | 1.08 | 1.04 | 0.90 |
| | Pigment | | | | |
| Inv. Ink 61 | Cyan | 1.08 | 1.16 | 1.13 | 0.97 |
| | Pigment | | | | |
| Inv. Ink 62 | Yellow | 1.05 | 1.11 | 1.02 | 1.06 |
| | Pigment | | | | |

| | |
|---|---|
| Ink 60 | TEB is the dispersing cosolvent at 20%; with a pigment/ |
| | dispersant ratio of 2.5 |
| Ink 61 | butyl carbitol is the dispersing cosolvent at 15%; with a p/d |
| | of 2.5 |
| Ink 62 | TEB is the dispersing cosolvent at 14.4%; with a p/d of 3.0 |

The composition of the inks were

### Composition of Ink Vehicle

| | |
|---|---|
| BYK-348 | 0.50% |
| Polyurethane ink Additive 14 | 8.0% |
| 1,2-Hexanediol | 5% |
| Dowanol TPM | 5% |
| Ethylene Glycol | 5% |
| water (Balance to 100%) | Balance |

Comparison of Conventional polymerically dispersed ink with PUD ink additive.

Inks were prepared with a ETEGMA//BZMA//MAA Dispersant as described at Comparison Dispersant Polymer 1. The inks were prepared without and with the polyurethane ink additive.

TABLE 10
Comparison Inks with Polyurethane Ink Additives

| | | | | Epson Photo Glossy | | |
|---|---|---|---|---|---|---|
| | | | on | Paper | | |
| | Polyurethane | % | 4024 | Gloss | Gloss | |
| | ink Additive | binder | O.D | @ 20° | @ 60° | DOI |
| Comp | None | 0 | 1.41 | 22.2 | 63.7 | 1.547 |
| Ink 18 | | | | | | |
| Comp | PUD 6 | 2 | 1.22 | 18 | 65.8 | 1.499 |
| Ink 19 | | | | | | |

The composition of the ink for these tests was in weight percent.

### 3.75% Pigment (Nipex 180IQ)

1.875% Acrylic Polymer (solid); the dispersant.
2.00% PUD ink additive 4

### 9.00% 2-Pyrrolidinone

### 2.00% Isopropal Alcohol

### 0.20% Neopental Alcohol

### 5.00% Liponics-EG1 (LEG)

### 0.20% Proxel GXL

### 75.975% Water

The PUD ink additive significantly lowers OD while the Gloss and DOI is almost unchanged. This conventionally dispersed pigment does not have the improved combination that an ISD and polyurethane ink additive has.

What is claimed is:

1. An aqueous pigmented ink jet ink comprising a polyurethane, an aqueous pigment dispersion in an aqueous vehicle, wherein: the aqueous pigment dispersion comprises an polymeric ionic dispersant and pigment where
(a) the polymeric ionic dispersant is physically adsorbed to the pigment,
(b) the polymeric ionic dispersant stably disperses the pigment in the aqueous vehicle,
(c) the average particle size of the dispersion is less than about 300 nm, and
(d) when three drops of the ink is added to about 1.5 g of an aqueous salt solution of about 0.20 molar salt, the pigment precipitates out of the aqueous salt solution when observed 24 hours after the addition; and
wherein the polyurethane is selected from the group consisting essentially of
a). an urea terminated polyurethane where the weight fraction of the urea-terminated polyurethane part of the polyurethane is at least 2 wt % to the urethane resin; and
b). a crosslinked polyurethane in the amount in the in jet ink of more than about 0.5% to about 30% by weight based on the total weight of the aqueous ink, and wherein the amount of crosslinking in the crosslinked polyurethane is greater than about 1% and less than about 50% as determined by the THF insolubles test.

2. The ink jet ink of claim 1 where the polyurethane is a urea terminated polyurethane comprising at least one compound of the general structure (I): 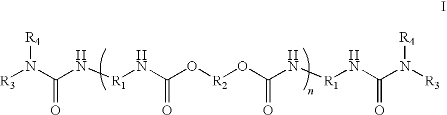
R₁=alkyl, substituted alkyl, substituted alkyl/aryl from a diisocyanate,
R₂=alkyl, substituted/branched alkyl from a diol,
R₃=hydrogen; alkyl; a non-isocyanate reactive substituted, isocyanate reactive substituted, or branched alkyl from the amine terminating group;
R₄=hydrogen; alkyl; a non-isocyanate reactive substituted, isocyanate reactive substituted, or branched alkyl from the amine terminating group;
where the isocyanate reactive group is selected from hydroxyl, carboxyl, mercapto, or amido;
n=2 to 30;
and where R₂=Z₁, Z₂ or Z₃ and at least one Z₁ or Z₃ and at least one Z₂ must be present in the polyurethane composition; 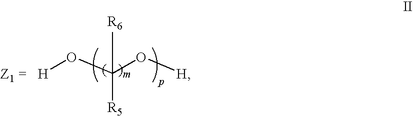
p greater than or equal to 1,
when p=1, m greater than or equal to 2 to about 36,
when p=2 or greater, m greater than or equal to 2 to about 12;
R₅, R₆=hydrogen, alkyl, substituted alkyl, aryl; where the R₅ is the same
or different with each R₅ and R₆ substituted methylene group where R₅ and R₅ or R₆ can be joined to form a cyclic structure;
Z₂ is a diol substituted with an ionic group;
Z₃ is selected from polyester diols, polycarbonate diols, polyestercarbonate diols and polyacrylate diols;
wherein Structure I denotes the urea terminating component and Structure II denotes the diol and/or a polyether diol that is a building block for Structure I.

3. The ink jet ink of claim 2 wherein the urea terminated polyurethane is of Structure II, where m=3 to 36.

4. The ink jet ink of claim 2 wherein the urea terminated polyurethane is of Structure II, where p is 2 or greater, m=3 to 12.

5. The ink jet ink of claim 1 where the polyurethane is from about 0.1 to about 12%, by weight based on the weight of the total ink composition.

6. The ink jet ink of claim 1 where the polyurethane is from about 0.2 to about 10% by weight based on the weight of the total ink composition.

7. The ink jet ink of claim 1 where the polyurethane is from about 0.25 to about 8% by weight based on the weight of the total ink composition.

8. The ink jet ink of claim 1, having from about 0.1 to about 10 wt % pigment based on the total weight of the ink, a weight ratio of pigment to dispersant of from about 0.5 to about 6, a surface tension in the range of about 20 dyne/cm to about 70 dyne/cm at 25° C., and a viscosity of lower than about 30 cP at 25° C.

9. The ink jet ink of claim 1 where the dispersant stably disperses the pigment in the aqueous vehicle,
(c) the average particle size of the dispersion is less than about 300 nm, and
(d) when three drops of the ink is added to about 1.5 g of an aqueous salt solution of about 0.20 molar salt, the pigment precipitates out of the aqueous salt solution when observed 24 hours after the addition; and the pigment precipitates out of the aqueous salt solution when observed 24 hours after the addition.

10. The ink jet ink of claim 1, where the polymeric ionic dispersant comprises a hydrophilic portion and a hydrophobic portion, wherein the hydrophobic portion is the predominant portion.

11. The polymeric ionic dispersant dispersion of claim 10, wherein the polymeric ionic dispersant is a copolymer of one or more hydrophilic monomers, and one or more hydrophobic monomers, the copolymer having a number average molecular weight great than about 300 and below about 30,000.

12. The ink jet ink of claim 1, wherein the weight ratio of pigment to polymeric ionic dispersant is about 0.5 to about 6.

13. The ink jet ink of claim 1, wherein the aqueous vehicle is a mixture of water and at least one water-miscible solvent.

14. An ink set comprising at least one cyan ink, at least one magenta ink and at least one yellow ink, wherein at least one of the inks is an aqueous pigmented ink jet ink as set forth in claim 1.

15. A method for ink jet printing onto a substrate, comprising the steps of:
(a) providing an ink jet printer that is responsive to digital data signals;
(b) loading the printer with a substrate to be printed;
(c) loading the printer with an ink as set forth in claim 14; and
(d) printing onto the substrate using the ink or inkjet ink set in response to the digital data signals.

16. The method for ink jet printing onto a substrate as set forth in claim 15, wherein the printer is loaded with an ink set as set forth in claim 15.
